(19) United States
(12) Patent Application Publication
(10) Pub. No.: US 2009/0288846 A1
(43) Pub. Date: Nov. 26, 2009

(54) DRY SPRINKLER SYSTEM AND DESIGN METHODS

(75) Inventor: David J. Leblanc, Uxbridge, MA (US)

Correspondence Address: FOR: TYCO FIRE SUPPRESSION & BUILDING PRODUCTS;PERKINS COIE LLP, 607 Fourteenth Street, NW, Washington, DC, 20005-2003, US

(73) Assignee: TYCO FIRE PRODUCTS LP, LANSDALE, PA (US)

(21) Appl. No.: 12/307,579

(22) PCT Filed: Jul. 5, 2007
(86) PCT No.: PCT/US07/72871

§ 371 Date: May 8, 2009

Related U.S. Application Data
(60) Provisional application No. 60/806,600, filed on Jul. 5, 2006.

(51) Int. Cl. A62C 35/62

(52) U.S. Cl. 169/17; 703/9

(57) ABSTRACT

A dry fire protection system, preferably for a storage occupancy, and its method of design are provided in which a fluid delivery delay period is identified and implemented. The preferred design method includes defining a ceiling height, a storage configuration, and storage height. The hydraulic demand for a wet system protecting the same defined storage occupancy is then identified. A fluid delivery delay period is then determined for the dry sprinkler system, preferably a maximum ADT, which results in a sprinkler operational area having a total number of sprinkler activations less than or equal to that defining the total hydraulic demand of the wet system. The preferred dry system can be further configured such that each and every sprinkler in the system has a fluid delivery delay period equal to or less than the maximum fluid delivery delay period.

### PRIORITY DATA AND INCORPORATION BY REFERENCE

This application claims the benefit of priority to U.S. Provisional Patent Application No. 60/806,600 filed Jul. 5, 2006 and which is incorporated by reference in its entirety.

### TECHNICAL FIELD

This invention relates generally to dry sprinkler fire protection systems and the method of their design and installation. More specifically, the present invention provides a dry sprinkler system, suitable for the protection of storage occupancies, which employs an inherent aspect of wet systems. The present invention is further directed to the method of designing and installing such systems.

### BACKGROUND OF THE INVENTION

A wet pipe sprinkler system, as is known in the art, includes a grid of spaced apart sprinkler heads or devices interconnected by a network of pipes pre-filled with a fire-fighting fluid such as, for example, water. The water is retained in the pipes by the thermally responsive valves in the sprinkler heads. A wet pipe sprinkler system can be disposed beneath the ceiling of a storage occupancy to provide wet sprinkler fire protection for the occupancy and any commodity stored therein. In operation, the wet sprinkler system responds to a fire growth by the initial thermal actuation and immediate fluid discharge from one or more sprinklers proximate the fire growth. As fluid is discharged from the initially actuated sprinklers, the fire may continue to grow and increasingly release heat and thereby subsequently actuate additional sprinklers until a sufficient number of sprinklers are actuated to immediately discharge fluid at a designed operating pressure to sufficiently sharply reduce or stop the rate of heat release. The total number of thermally actuated and discharging sprinklers in response to the fire define an effective sprinkler operational area for the wet system and thereby define a fluid or water demand for the known wet system.

A dry sprinkler system, as is known in the art, also includes a grid of sprinkler devices or heads interconnected by a network of pipes and can also be configured for the protection of a storage occupancy. The network of interconnected pipes initially contain air or other gas, which is retained by the thermally responsive valves in the sprinklers devices. The dry sprinkler grid and its network of pipes are placed in controlled communication with a fire-fighting fluid-source such as, for example, a water main, by way of a primary water supply control valve, which can include, for example, an air-to-water ratio valve, deluge valve or preaction valve as is known in the art. There are three types of dry sprinkler systems; these dry systems include: dry pipe, preaction, and deluge systems. In a deluge system, the network of pipes are initially free of water, employs sprinkler heads that remain open, and utilize pneumatic or electrical detectors to detect an indication of fire such as, for example, smoke or heat. A preaction system has pipes that are free of water, employs sprinkler heads that remain closed, has supervisory air, and utilizes pneumatic or electrical detectors to detect an indication of fire such as, for example, heat or smoke. Only when the deluge or preaction system detects a fire is water introduced into the otherwise dry network of pipes and sprinkler heads. A dry pipe system includes fluid flow pipes which are charged with air under pressure and when the dry pipe system detects heat from a fire, the sprinkler heads open resulting in a decrease in air pressure. The resultant decrease in air pressure activates the primary control valve to allows fluid to enter the piping system and exit through the sprinkler heads.

More specifically, in the operation of a dry pipe non-preaction or preaction sprinkler system, one or more normally closed sprinklers of the system open when sufficiently heated or triggered by a thermal source such as a fire growth. The initially open sprinkler heads, alone or in combination with a smoke or fire indicator (preaction), causes the primary water supply valve to open, thereby allowing the fluid to fill the network of pipes and displace the air or gas therein. As the fluid travels through the network of pipes to the actuated sprinklers, the fire below continues to grow to thermally actuate additional sprinklers. The fluid in the pipes eventually reaches the actuated sprinklers and fluid is discharged into the occupancy, and provided the system is properly hydraulically designed, achieves operating discharge pressure to control the fire, reduce the smoke source, and/or minimize any damage therefrom. Accordingly, dry sprinkler systems, unlike wet systems, present a delay between the moment of thermal actuation of a sprinkler and the moment of fluid discharge at operating pressure from the actuated sprinkler. The actual delay time (“ADT”) for dry systems consists of three intervals: (i) the first interval can be defined from the moment of first sprinkler actuation to the moment the control valve trips open, i.e. “trip time;” (ii) the second interval can be defined from the moment the control valve trips open to the moment fluid reaches the open sprinklers; (iii) and the third interval can be defined from the moment the fluid reaches the open sprinklers to the moment the fluid discharges from the open sprinklers at operating pressure, i.e. the “compression time.” Factors impacting the ADT include the dry system volume, the piping layout, the initial pressure of the gas and fluid in the system, the control valve tripping mechanism, and the hydraulic characteristics of the fluid supply, the sprinkler and the sprinkler actuation or opening sequence.

Currently, there exists an industry-wide belief that in dry sprinkler systems it is best to minimize or if possible, avoid fluid delivery delay. This belief has led to an industry-wide perception that dry sprinkler systems are inferior to wet systems. Current industry accepted design standards attempt to address or minimize the impact of the fluid delivery delay by placing a limit on the amount of delay that can be in the system. For example, The National Fire Protection Association (NFPA) provides in its standard, NFPA-13 Standard for the Installation of Sprinkler Systems (hereinafter “NFPA-13”) (The sections of NFPA-13 cited herein refer to the 2002 edition, NFPA-13 has since been updated to the 2007 edition in which corresponding sections can be accordingly referenced). NFPA-13, Sections 7 and 11 provide that the water must be delivered from the primary water control valve to discharge out of the sprinkler head in under sixty seconds and more specifically under forty seconds. To promote the rapid delivery of water in dry sprinkler systems, Section 7 of the NFPA-13 further provides that, for dry sprinkler systems having system volumes between 500 and 750 gallons, the discharge time-limit can be avoided provided the system includes quick-opening devices such as accelerators.

NFPA-13 provides for additional provisions in the design of dry protection systems used for protecting stored commodities. For example, NFPA requires that the design area for a dry sprinkler system be increase in size as compared to a wet systems for protection of the same area or space. Specifically, NFPA-13-Section 12.1.6.1 provides that the area of sprinkler operation, the design area, for a dry system shall be increased by 30 percent (without revising the density) as compared to an equivalent wet system. This increase in sprinkler operational area establishes a “penalty” for designing a dry system; again reflecting an industry belief that dry sprinkler systems are inferior to wet.

In complying with the thirty percent design area increase “penalty,” fire protection system engineers and designers are forced to anticipate the activation of more sprinklers and thus perhaps provide for larger piping to carry more water, larger pumps to properly pressurize the system, and larger tanks to make-up for water demand not satisfied by the municipal water supply. Despite the apparent economic design advantage of wet systems over dry systems, certain storage configurations prohibit the use of wet systems or make them otherwise impractical. Dry sprinkler systems are typically employed for the purpose of providing automatic sprinkler protection in unheated occupancies and structures that may be exposed to freezing temperatures. For example, in warehouses using high rack storage, i.e. 25 ft. high storage beneath a 30 ft. high ceiling, such warehouses that are unheated and therefore sprinkler systems are also susceptible to freezing conditions making wet systems undesirable. Freezer storage presents another environment that cannot utilize wet systems because water in the piping of the fire protection system located in the freezer system would freeze.

Dry sprinkler system performance and its inherent fluid delivery delay have been the focus of prior investigations. In the early 1970s a theoretical model for predicting trip time and transit time of tree-type dry-pipe sprinkler systems for a given sprinkler opening sequence was developed and described in a series of technical reports from Factory Mutual Research Corporation (FMRC): (i) Heskestad G. and Kung, H. C., “Transient Response of Dry-Pipe Sprinkler System, Progress Report No. 2”—Technical Report FMRC Serial No. 15918 (1971); and (ii) Heskestad and Kung, “Relative Water Demands of Wet and Dry-Pipe Sprinkler Systems, Progress Report No. 3 (Final)”—Technical Report FMRC Serial No. 15918 (1973). A computer model based on the theoretical model has been used to predict the trip time and transit time for various systems. The authors of another FMRC technical report developed a computer software program that combined the theoretical model with a sprinkler response prediction model for warehouses to predict the fire size and the number of sprinkler openings of a dry-pipe system at the time of water arrival in the event of a storage fire under a thirty foot high horizontal smooth ceiling. See Nam S. and Kung, H. C., “Theoretical Prediction of Water Delay Time of Dry Pipe Sprinkler Systems in the Event of Fire,” Technical Report FMRC J.I.0T0R8.RA (1993). Additional analyses regarding the performance of dry-pipe systems is provided in a publication entitled “A Technical Analysis: Variables That Affect the Performance of Dry Pipe Systems” by James Golinveaux (2002). Accordingly, the effects of system volume, system layout, sprinkler sensitivity and temperature rating have been investigated.

TYCO has also recently sponsored a series of large scale rack-storage tests of Class II, Class III and Group A Plastic commodities at Underwriters Laboratories, Inc. (“UL”) to collect test data regarding dry-pipe system fire protection for storage occupancies and the impact of ADT. In each test, the total number of sprinkler operations was obtained and the total system water demand was determined for a specified trip time delay as specified by TYCO. Details and results of the tests are provided and summarized in the UL test report entitled, “Fire Performance Evaluation of Dry-pipe Sprinkler Systems for Protection of Class II, III and Group A Plastic Commodities Using K-16.8 Sprinkler: Technical Report Underwriters Laboratories Inc. Project 06NK05814, EX4991 for Tyco Fire & Building Products 06-02-2006.” (hereinafter “UL 2006 Report”).

Reviewers of the UL 2006 Report concluded that the relationship between ADT and the dry sprinkler system water or fluid demand requires further development. In particular, the reviewers posited that the final number of sprinkler operations and total water demand for a wet system protecting a given storage configuration can serve as a benchmark for comparison with the number of sprinkler operations and the fluid demand of a dry pipe system protecting a similar storage configuration. Moreover, the reviewers proposed that in a free burn test for protection of the given storage configuration, the time lapse between the first sprinkler activation to a number of sprinkler activations equal to the total actuated in a wet system for the same storage configuration defines a critical burn time (“CBT”). Accordingly, the reviewers posed the question of whether a relationship exists between the ADT and the CBT to thereby define the fluid demand of a dry system. More specifically, the reviews asked that if it is expected that the total number of sprinkler activations in a dry pipe system are greater than that of a wet system for the protection of the same storage configuration when the ADT of the dry system is greater than the CBT for similar storage configuration, then is the fluid demand of a dry system the same as that of a wet system for protection of the same storage configuration when the ADT is less than the CBT?

### DISCLOSURE OF INVENTION

A novel design methodology and configuration of dry sprinkler systems is provided that applies the concepts of the CBT and ADT to overcome the hydraulic design penalties imposed by current sprinkler design standards. More specifically provided is a preferred method of designing a dry sprinkler system for the fire protection of a storage occupancy defining a ceiling height and having a commodity stored therein of a commodity classification in a storage configuration to further define a storage height. The preferred method includes identifying the hydraulic demand for a wet system protecting the same defined storage occupancy and stored commodity configuration. The method further includes identifying a maximum fluid delivery delay period for the dry sprinkler system, preferably a maximum ADT, that results in a sprinkler operational sequence having a total number of sprinkler activations less than that defining the total hydraulic demand of the wet system. The dry system is further configured and/or arranged such that each and every sprinkler in the system has a fluid delivery delay period that is equal to or less than the maximum fluid delivery delay period.

The inventor believes that designing a dry sprinkler system with the preferred fluid delivery delay period would result in a dry system having a system performance equivalent to a wet system protecting a similar storage occupancy and stored commodity configuration. More specifically, a dry sprinkler system having the maximum fluid delivery delay period resulting in fewer sprinkler activations than that defining the total hydraulic demand of the wet system would preferably address a fire event with an initial number of sprinkler activations having fluid discharge at a designed operating pressure. Preferably, the dry sprinkler system would experience subsequent sprinkler activations until the total number of sprinkler activations were substantially equivalent to the number of sprinkler activations defining the total hydraulic demand of the wet system, as preferably defined by full scale fire testing or alternatively defined by the applicable fire standards such as NFPA-13. The fluid discharging from the resultant total number of sprinkler activations at design pressure in the dry system preferably provides an equivalent performance to that of a wet system protecting a similar storage occupancy and storage configuration so as to effectively address the fire event. Accordingly, the resultant total number of sprinkler activations in the dry sprinkler system employing the preferred method provides a hydraulic demand for the system that is preferably less than required by current design standards for dry sprinkler systems.

In one preferred method of designing a dry sprinkler system for a storage occupancy having a network of pipes including a wet portion and a dry portion, the method includes determining the inherent design area of a wet system configured to protect the same storage occupancy, determining a critical burn time to form the inherent design area, and incorporating a fluid delivery delay period into the dry system, in which the fluid delivery delay period is no greater than the critical burn time.

In another preferred embodiment, a dry sprinkler system for protection of a storage occupancy is provided having a network of pipes including a wet portion and a dry portion connected to the wet portion. The dry portion is configured to respond to a fire with at least a first activated sprinkler. The system includes a fluid delivery delay period to deliver fluid from the wet portion to the at least first activated sprinkler. The delay period is preferably configured with a sufficient length such that the dry portion responds to the fire with at least a second activated sprinkler and is no greater than the critical burn time of a wet system configured to protect the same storage occupancy. Preferably, the first activated sprinkler includes a plurality of initially activated sprinklers in response to the fire, in which the plurality of initially activated sprinklers may be thermally activated in a defined sequence.

The preferred dry sprinkler system further includes a primary water control valve providing controlled separation between the wet portion and the dry portion, and the dry portion includes at least one hydraulically remote sprinkler and at least one hydraulically close sprinkler relative to the primary water control valve. In one aspect, the fluid delivery delay period preferably defines a minimum fluid delivery delay period and a maximum fluid delivery delay period. The minimum fluid delivery delay period preferably defines the time to deliver fluid from the control valve to the at least one hydraulically close sprinkler, and the maximum fluid delivery delay period defines the time to deliver fluid from the control valve to the at least one hydraulically close sprinkler.

In another aspect of the preferred system, the dry portion includes a plurality of sprinklers having a K-factor of about 11 or greater and an operating pressure of about 15 psi. or greater, the dry portion being disposed above a commodity comprising at least one of Class I-IV, Group A, Group B or Group C with a storage height greater than twenty-five feet. The plurality of sprinklers can further have a K-factor ranging from about 11 to about 36, is preferably about 17, and more preferably about 16.8. The operating pressure of the sprinklers can ranges from about 15 psi. to about 60 psi, preferably ranges from about 15 psi. to about 45 psi, more preferably ranges from about 20 psi. to about 35 psi, and is even more preferably about 35 psi.

In operation, the preferred dry sprinkler system defines an effective sprinkler operational area within about ten minutes following the activation of the at least first activated sprinkler, preferably within about eight minutes following the activation of the at least first activated sprinkler, and even more preferably within about five minutes following the activation of the at least first activated sprinkler.

### BRIEF DESCRIPTIONS OF THE DRAWINGS

The accompanying drawings, which are incorporated herein and constitute part of this specification, illustrate exemplary embodiments of the invention, and, together with the general description given above and the detailed description given below, serve to explain the features of the invention.

FIGS. 1A-1C are illustrative sprinkler activation and heat release profiles for a wet sprinkler system in the protection of a storage occupancy.

FIG. 2 an illustrative flowchart for performing a preferred method according to the present invention.

FIG. 2A-2B is a schematic view of a storage occupancy for use in the method of FIG. 2

FIG. 2C is an illustrative flowchart for determining an operating sequence in the method of FIG. 2

FIG. 3 is an illustrative predictive sprinkler activation profile for use in the method of FIG. 2.

FIG. 4 is an illustrative fire test sprinkler activation plot for use in the method of FIG. 2.

FIG. 5 is another predictive sprinkler activation profile used in the method of FIG. 2

FIG. 5A is another sprinkler activation plot from a dry system storage commodity fire test designed using the method of FIG. 2.

FIG. 5B is another sprinkler activation plot of the test in FIG. 5A.

FIG. 5C is a sprinkler activation plot from a wet system fire test for the same storage commodity in the test of FIG. 5A.

FIG. 5D is a sprinkler activation plot from a free burn fire test for the same storage commodity in the test of FIG. 5A.

FIG. 6 is a schematic view of a dry sprinkler system incorporating the design method of FIG. 2.

FIG. 7 is a schematic of a computer processing device for practicing one or more aspects of the preferred systems and methods of fire protection.

FIG. 8 is a schematic view of a network for practicing one or more aspects of the preferred systems and methods of fire protection.

FIG. 9 is a schematic flow diagram of the lines of distribution of the preferred systems and methods.

### MODE(S) FOR CARRYING OUT THE INVENTION

A preferred methodology for the design of a dry sprinkler system can be provided in which the dry sprinkler system has an operational performance equivalent to that of a wet system. More specifically, the preferred methodology provides for designing a dry sprinkler fire protection system to protect a storage occupancy having a defined ceiling height to store a commodity of a defined commodity class, storage configuration and storage height. The dry sprinkler system is preferably configured to hydraulically perform the same as a wet system configured to protect a substantially similar storage occupancy and commodity arrangement. Accordingly, the preferred method of dry sprinkler design is based upon the use of wet sprinkler performance as a bench mark.

In particular, the preferred design methodology relies upon a presumption about wet sprinkler performance. It is believed that a wet sprinkler system has an inherent design area (IDA) which is defined by a total number of thermally actuated sprinklers discharging a fire fighting fluid, such as water, at a designed operating pressure in response to a fire event. The IDA is more specifically a total number of sprinklers sufficient to control the fire event. More preferably, the IDA is effective to provide a sufficient level of control capability independent of the operating time and sequence of the sprinklers forming the IDA, i.e. whether all the sprinkler in the IDA open independently over time or all together simultaneously, the actuated sprinklers provide the same level of control.

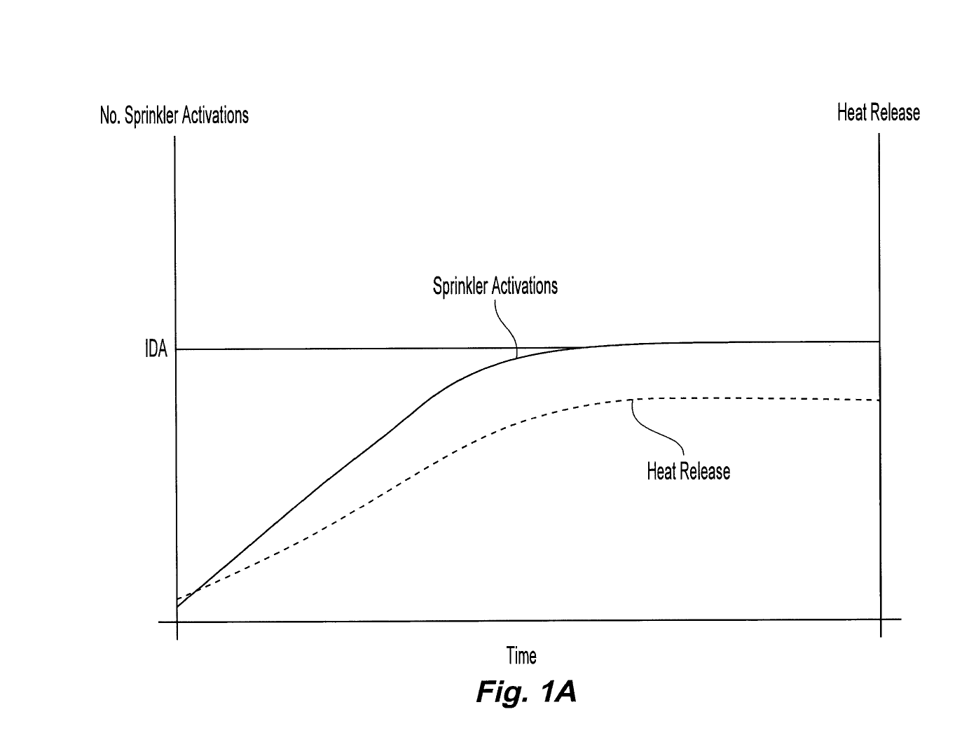

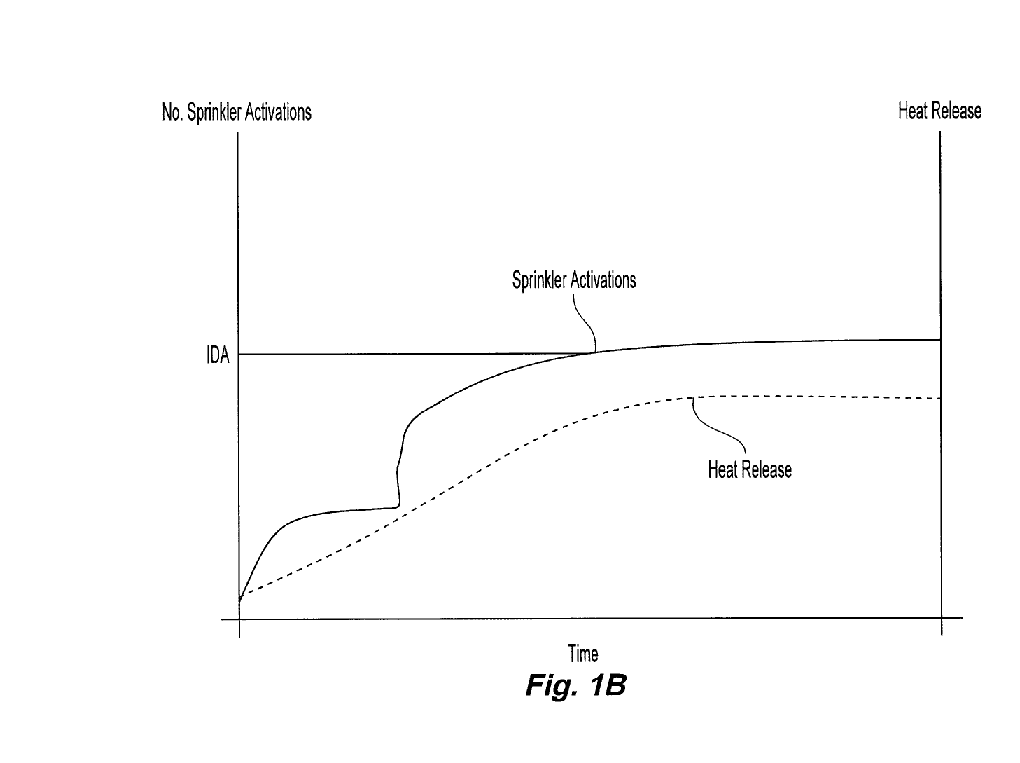

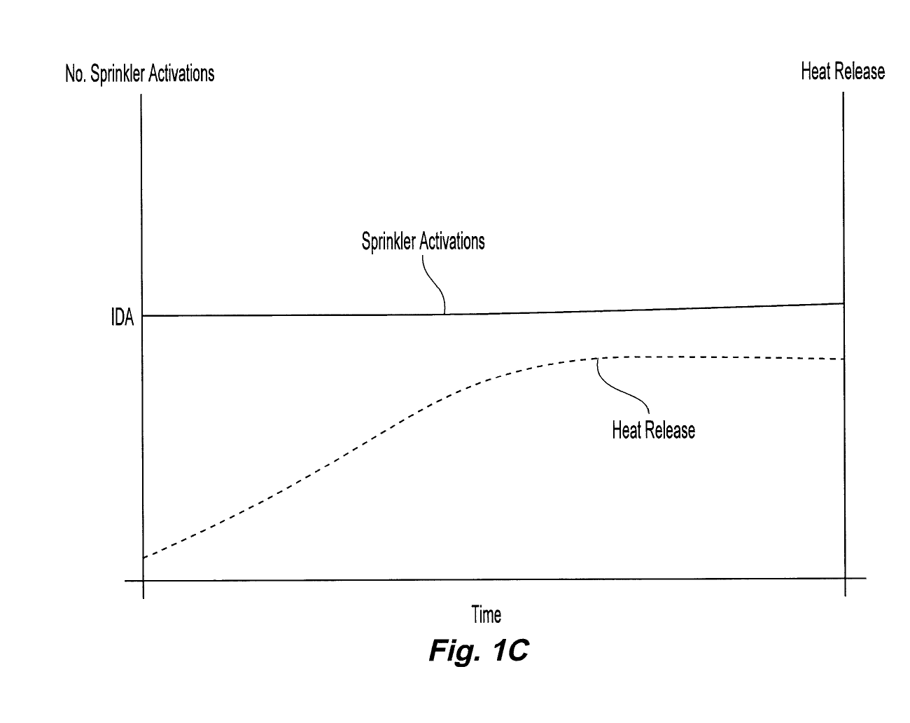

Shown in FIGS. 1A-1C are illustrative sprinkler activation and heat release rate profiles for a wet system stored beneath the ceiling of a storage occupancy and above a stored commodity configuration. Each of the plots identify an exemplary IDA of twenty thermally activated sprinklers in response to a given heat release profile 20 of a fire event. FIG. 1A shows a sprinkler activation occurring at a relatively constant rate following an initial sprinkler activation to reach the IDA. FIG. 1B shows the IDA being achieved in a step-wise fashion and FIG. 1C shows the IDA being formed by the simultaneous thermal actuation of twenty sprinklers. Regardless of the sequence or time at which the any of the twenty sprinklers forming the IDA actuate, fluid is immediately discharged into the storage occupancy, eventually reaches operating pressure in all of the actuated sprinklers of the IDA and the heat release rate of the fire growth ceases to increase. Accordingly, once the fire is controlled such that the heat release is constant and no additional sprinkler activations occur, the total number of sprinkler activations effectively define the IDA for the wet system.

Because the IDA in a wet system is believed to be independent of sprinkler activation sequence or timing, the inventor has developed a design methodology to optimize the hydraulic demand in a dry system based upon the IDA and its ability to effectively address a fire event. The preferred design methodology generally includes identifying for a dry sprinkler system located in a defined storage occupancy above a defined stored commodity configuration, a fluid delivery delay period, preferably the ADT of the dry sprinkler system, that would result in an initial sprinkler operating area discharging at designed fluid pressure. Preferably, the number of sprinklers forming the initial operating area is equal to or more preferably less than the number of activated sprinklers forming IDA of a wet system protecting a substantially similar storage occupancy and stored commodity configuration. The design methodology further preferably provides that the initial sprinkler operating area, discharging fluid at a desire operating pressure, would grow with additional sprinkler activations so as to form a final sprinkler operating area substantially equivalent in sprinkler activations to the IDA of the wet system protecting a substantially similar occupancy and commodity configuration. More specifically, the design methodology preferably provides that upon discharge of fluid from the initial sprinkler operating area at designed operating pressure, the dry sprinkler system behaves substantially similar to a wet system configured for protection of a substantially similar storage occupancy and stored commodity configuration.

Because the final sprinkler operating area is preferably defined by substantially the same number of sprinkler activations that form the IDA, the final sprinkler operating area is equally effective in addressing a fire event as the IDA of the wet system. The preferred fluid delivery delay period of the dry system may define a range of possible fluid delivery delay periods. Preferably each unit of delay within the range can define an initial sprinkler operational area equal to or smaller than the IDA of a wet system configured to protect a similarly configured storage occupancy and stored commodity. The preferred range of delivery delay periods includes a maximum fluid delivery delay period and preferably a minimum fluid delivery delay period. The maximum permissible fluid delivery delay period is preferably defined to the point at which any greater a delay period would result in a final sprinkler operation area having a number of thermally actuated sprinklers significantly greater than that forming the IDA of the wet system. A final sprinkler area greater than the IDA can compromise dry sprinkler performance because the designed operating fluid discharge pressure fails to be achieved due to the final sprinkler operating area being too large to be hydraulically supported by the fluid source.

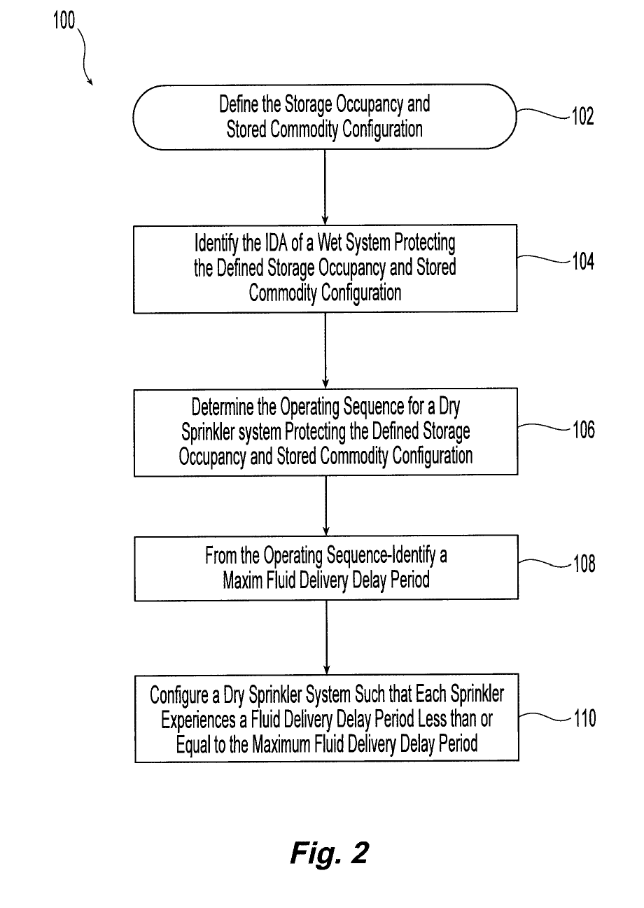

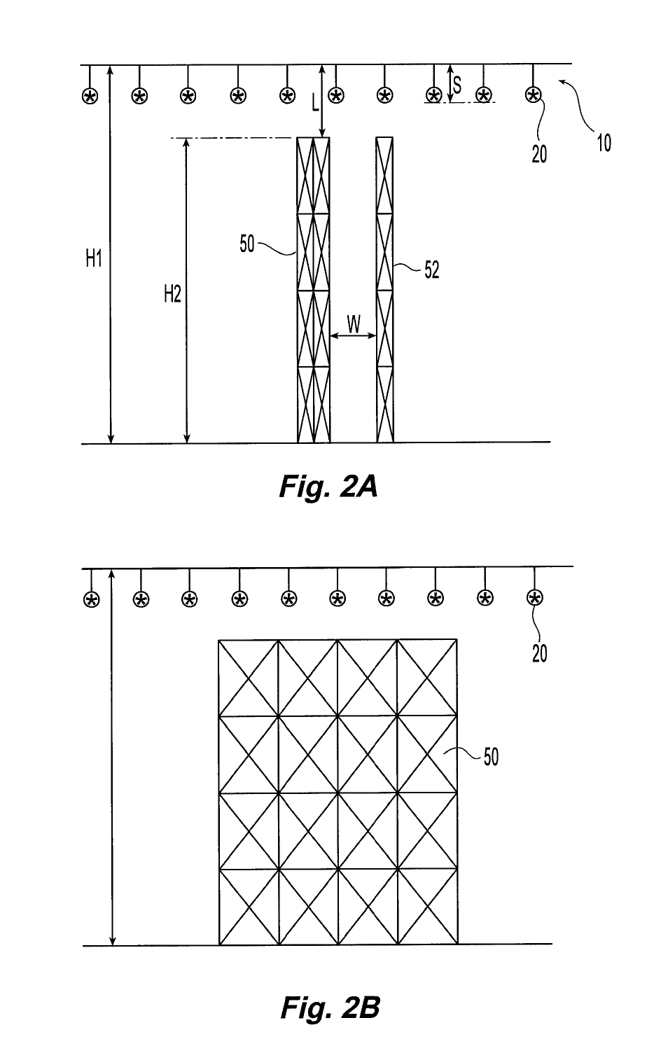

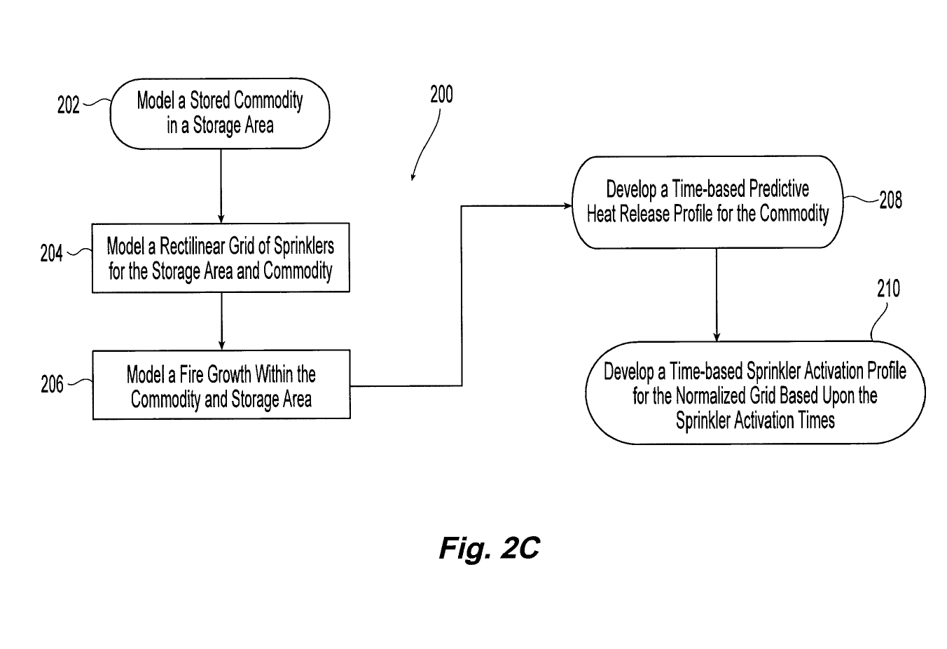

Shown in FIG. 2 is a flowchart showing a preferred embodiment of the design methodology 100. The preferred method 100 includes a storage defining step 102 in which the storage occupancy and the commodity configuration to be protected is defined. Preferably, defining the occupancy includes defining the ceiling height, the commodity class, the storage configuration, storage height and the sprinkler-to-storage clearance height, as schematically shown, for example, in FIGS. 2A and 2B. More specifically shown is a storage occupancy having a ceiling height H1. Contained within the storage occupancy is a stored commodity 50, further preferably included is at least one target array 52 spaced from the stored commodity 50 at an aisle width W. Further shown is sprinkler system 10 having a grid of sprinklers 20 suspended from the ceiling of the occupancy. The sprinklers 20 are suspended from the ceiling to preferably define a sprinkler deflector-to-ceiling distance S and a sprinkler-to-storage clearance height L. The sprinkler 20 can be any sprinkler configured for dry sprinkler installation provided the sprinkler can provide the thermal responsiveness, fluid volume, distribution, velocity to provide the cooling and fire management effectiveness as when installed in a wet system.

The preferred method includes an IDA identifying step 104 to identify the IDA of a wet system configured to provide fire protection for the storage occupancy and stored commodity defined in the defining step 102. Preferably, the IDA identifying step 104 includes constructing a wet sprinkler system preferably using the sprinkler that is to be used in the dry sprinkler design. A full scale fire test is preferably conducted beneath the wet sprinkler system and the total number of sprinklers to effectively address the test fire is counted to identify and define the IDA of the wet system.

The preferred design method 100 further preferably includes a sequence identifying step 106 which includes determining the operating sequence of a dry sprinkler system in the absence of water discharge into the storage occupancy. The sequencing identifying step 106 can be completed by one of two approaches: (i) a computational approach; and (ii) an empirical approach. The computational approach generally provides computational modeling of a dry sprinkler system disposed above the defined storage occupancy and the stored commodity that are preferably defined in the storage defining step 102 with a fire simulated below and in the absence of any fire-fighting fluid being introduced into the occupancy. From the model, the sprinkler activations times are predicted in response to the predicted heat release.

The National Institute of Standards and Technology (NIST) has developed a software program entitled Fire Dynamics Simulator (FDS), currently available from the NIST website at Internet:<URL:http://fire.nist.gov/fds/. FDS models the solution of fire driven flows, i.e. fire growth, including but not limited to flow velocity, temperature, smoke density and heat release rate. These variables are further used in the FDS to model sprinkler system response to a fire.

FDS can be used to model sprinkler activation or operation of a dry sprinkler system in the presence of a growing fire for a stored commodity. One particular study has been conducted using FDS to predict fire growth size and the sprinkler activation patterns for two standard commodities and a range of storage heights, ceiling heights and sprinkler installation locations. The findings and conclusions of the study are discussed in a report by the inventor entitled, “Dry Pipe Sprinkler Systems—Effect of Geometric Parameters on Expected Number of Sprinkler Operation” (2002) (hereinafter “FDS Study”).

The FDS Study evaluated predictive models for dry sprinkler systems protecting storage arrays of Group A and Class II commodities. The FDS Study generated a model that simulated fire growth and sprinkler activation response. The study further verified the validity of the prediction by comparing the simulated results with actual experimental tests. As described in the FDS study, the FDS simulations can generate predictive heat release profiles for a given stored commodity, storage configuration and commodity height showing in particular the change in heat release over time and other parameters such as temperature and velocity within the computational domain for an area such as, for example, an area near the ceiling. In addition, the FDS simulations can provide sprinkler activation profiles for the simulated sprinkler network modeled above the commodity showing in particular the predicted location and time of sprinkler activation.

Developing the predictive profiles includes modeling the commodity to be protected in a simulated fire scenario beneath a sprinkler system. To model the fire scenario, at least three physical aspects of the system to be model are considered: (i) the geometric arrangement of the scenario being modeled; (ii) the fuel characteristics of the combustible materials involved in the scenario; and (iii) sprinkler characteristics of the sprinkler system protecting the commodity. The model is preferably developed computationally and therefore to translate the storage space from the physical domain into the computation domain, nonphysical numerical characteristics must also be considered.

Computation modeling is preferably performed using FDS, as described above, which can predict heat release from a fire growth and further predict sprinkler activation time. NIST publications are currently available which describe the functional capabilities and requirements for modeling fire scenarios in FDS. These publications include: NIST Special Publication 1019: Fire Dynamics Simulator (Version 4) User's Guide (September 2005) and NIST Special Publication 1018: Fire Dynamics Simulator (Version 4) Technical Reference Guide (September 2005). Alternatively, any other fire modeling simulator can be used so long as the simulator can predict sprinkler activation or detection.

As is described in the FDS Technical Reference Guide, FDS is a Computational Fluid Dynamics (CFD) model of fire-driven fluid flow. The model solves numerically a form of the Navier-Stokes equations for low-speed, thermally driven flow with an emphasis on smoke and heat transportation from fires. The partial derivatives of the conservation of mass equations of mass, momentum, and energy are approximated as finite differences, and the solution is updated in time on a three-dimensional, rectilinear grid. Accordingly, included among the input parameters required by FDS is information about the numerical grid. The numerical grid is one or more rectilinear meshes to which all geometric features must conform. Moreover, the computational domain is preferably more refined in the areas within the fuel array where burning is occurring. Outside of this region, in areas were the computation is limited to predicted heat and mass transfer, the grid can be less refined. Generally, the computational grid should be sufficiently resolved to allow at least one, or more preferably two or three complete computational elements within the longitudinal and transverse flue spaces between the modeled commodities. The size of the individual elements of the mesh grid can be uniform, however preferably, the individual elements are orthogonal elements with the largest side having a dimension of between 100 and 150 millimeters, and an aspect ratio of less than 0.5.

Shown in FIG. 2C is a preferred flowchart 200 for predictive modeling. In the first step 202 of the predictive modeling method, the commodity is preferably modeled in its storage configuration to account for the geometric arrangement parameters of the scenario. These parameters preferably include locations and sizes of combustible materials, the ignition location of the fire growth, and other storage space variables such as ceiling height and enclosure volume. In addition, the model preferably includes variables describing storage array configurations including the number of array rows, array dimensions including commodity array height and size of an individual commodity stored package, and ventilation configurations.

In one modeling example, as described in the FDS study, an input model for the protection of Group A plastics included modeling a storage area of 110 ft. by 10 ft; ceiling heights ranging from twenty feet to forty feet. The commodity was modeled as a double row rack storage commodity measuring 33 ft. long by 7½ ft. wide. The commodity was modeled at various heights including between twenty-five feet and forty feet.

In the modeling step 204 the sprinkler system is modeled so as to include sprinkler characteristics such as sprinkler type, sprinkler location and spacing, total number of sprinklers, and mounting distance from the ceiling. The total physical size of the computational domain is preferably dictated by the anticipated number of sprinkler operations prior to fluid delivery. Moreover, the number of simulated ceiling and associated sprinklers are preferably large enough such that there remains at least one continuous ring of inactivated sprinklers around the periphery of the simulated ceiling. Generally, exterior walls can be excluded from the simulation such that the results apply to an unlimited volume, however if the geometry under study is limited to a comparatively small volume, then the walls are preferably included. Thermal properties of the sprinkler are also preferably included such as, for example, functional RTI and activation temperature. More preferably, the RTI for the thermal element of the modeled sprinkler is known prior to its installation in the sprinkler. Additional sprinkler characteristics can be defined for generating the model including details regarding the water spray structure and flow rate from the sprinkler. Again referring to the FDS Study, for example, a sprinkler system was modeled with a twelve by twelve grid of Central Sprinkler ELO-231 sprinklers on 10 ft. by 10 ft. spacing for a total of 144 sprinklers. The sprinklers were modeled with an activation temperature of 286° F. with an RTI of 300 (ft-sec)^{1/2}. The sprinkler grid in the FDS Study was disposed at two different heights from the ceiling: 10 inches and 4 inches.

A third aspect 206 to developing the predictive heat release and sprinkler activation profiles preferably provides simulating a fire disposed in the commodity storage array over a period of time. Specifically, the model can include fuel characteristics to describe the ignition and burning behavior of the combustible materials to be modeled. Generally, to describe the behavior of the fuel, an accurate description of heat transfer into the fuel is required.

Simulated fuel masses can be treated either as thermally thick, i.e. a temperature gradient is established through the mass of the commodity, or thermally thin, i.e. a uniform temperature is established through the mass of the commodity. For example, in the case of cardboard boxes, typical of warehouses, the wall of the cardboard box can be assumed to have a uniform temperature through its cross section, i.e. thermally thin. Fuel parameters, characterizing thermally thin, solid, Class A fuels such as the standard Class II, Class III and Group A plastics, preferably include: (i) Heat Release Per Unit Area; (ii) Specific Heat; (iii) Density; (iv) Thickness; and (v) Ignition temperature. The Heat Release per unit area parameter permits the specific details of the internal structure of the fuel to be ignored and the total volume of the fuel to be treated as a homogeneous mass with a known energy output based upon the percentage of fuel surface area predicted to be burning. Specific Heat is defined as the amount of heat required to raise the temperature of one unit mass of the fuel by one unit of temperature. Density is the mass per unit volume of the fuel, and thickness is the thickness of the surface of the commodity. Ignition Temperature is defined as the temperature at which the surface will begin burning in the presence of an ignition source.

For fuels which cannot be treated as thermally thin, such as a solid bundle of fuel, additional or alternative parameters may be required. The alternative or additional parameters can include thermal conductivity which can measure the ability of a material to conduct heat. Other parameters may be required depending on the specific fuel that is being characterized. For example, liquid fuels need to be treated in a very different manner than solid fuels, and as a result the parameters are different. Other parameters which may be specific for certain fuels or fuel configurations include: (i) Emissivity, which is the ratio of the radiation emitted by a surface to the radiation emitted by a blackbody at the same temperature and (ii) heat of vaporization which is defined as the amount of heat required to convert a unit mass of a liquid at its boiling point into vapor without an increase in temperature. Any one of the above parameters may not be fixed values, but instead may vary depending on time or other external influence such as heat flux or temperature. For these cases, the fuel parameter can be described in a manner compatible with the known variation of the property, such as in a tabular format or by fitting a (typically) linear mathematical function to the parameter. Accordingly, any commodity such as those defined in NFPA-13 can be appropriately characterized and modeled provided the fuel parameters are properly characterized.

Generally, each pallet of commodity can be treated as homogeneous package of fuel, with the details of the pallet and physical racks omitted. Exemplary combustion parameters, based on commodity class, are summarized in the Combustion Parameter Table below.

Combustion Parameter Table

| | | | Group A |
|---|---|---|---|
| | Class II | Class III | Plastic |
| Heat Release per Unit Area (kW/m2) | 170-180 | 180-190 | 500 |
| specific heat*density*thickness (m) | 1 | 0.8 | 1 |
| Ignition Temperature (° C.) | 370 | 370 | 370 |

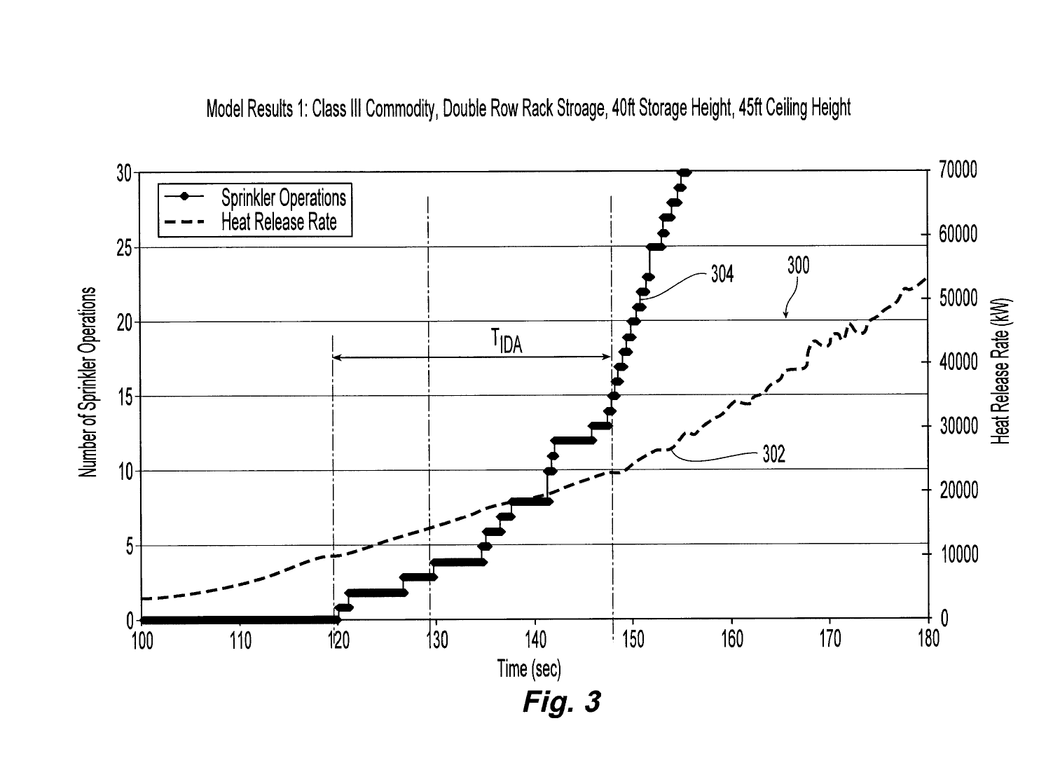

From the fire simulation, the FDS software or other computational code solves for the heat release and resulting heat effects including one or more sprinkler activations for each unit of time as provided in steps 208, 210. The sprinkler activations may be simultaneous or sequential or a combination thereof. It is to be further understood that the heat release solutions define a level of fire growth through the stored commodity. It is further understood that the modeled sprinklers are thermally activated in response to the heat release profile. Therefore, for a given fire growth there is a corresponding number of sprinklers that are thermally activated or open. Again, the simulation preferably provides that upon sprinkler activation no water is delivered, i.e. a free-burn simulation. Modeling the sprinklers without the discharge of water ensures that the heat release profile and therefore fire growth is not altered by the introduction of water. The heat release and sprinkler activation solutions are preferably plotted as time-based predictive heat release and sprinkler activation profiles 300 in steps 208, 210 as seen, for example, in FIG. 3. Alternatively, or in addition to, the heat release and sprinkler activation profile, a schematic and/or tabular plot of the sprinkler activations can be generated showing locations of activated sprinklers relative to the storage array and ignition point, time of activation and heat release at time of activation.

Predictive profiles 300 of FIG. 3 provide illustrative examples of predictive heat release profile 302 and predictive sprinkler activation profile 304. From the predictive profile, the time from first sprinkler activation to the number of sprinkler activations equivalent to the IDA can be identified as the predicted t_{IDA} equivalent time. From t_{IDA} equivalent time, one can preferably select a shorter period of time as the maximum fluid delivery delay period for incorporation into the system design.

Alternatively, a empirical approach to identifying the thermal operating sequence can be employed. Preferably, a full scale dry storage occupancy fire test is conducted in which the sprinklers are thermally actuated but no fire-fighting fluid or water is introduced into the storage occupancy, i.e. a free-burn test. In the free-burn test, the test sprinkler grid is preferably constructed using the same sprinkler utilized in the wet system fire test and more preferably considered for use in the dry sprinkler system design. Alternatively, the free-burn test grid can be constructed using a sprinkler having the same K-factor and thermal responsiveness as that of the sprinklers in the wet system test.

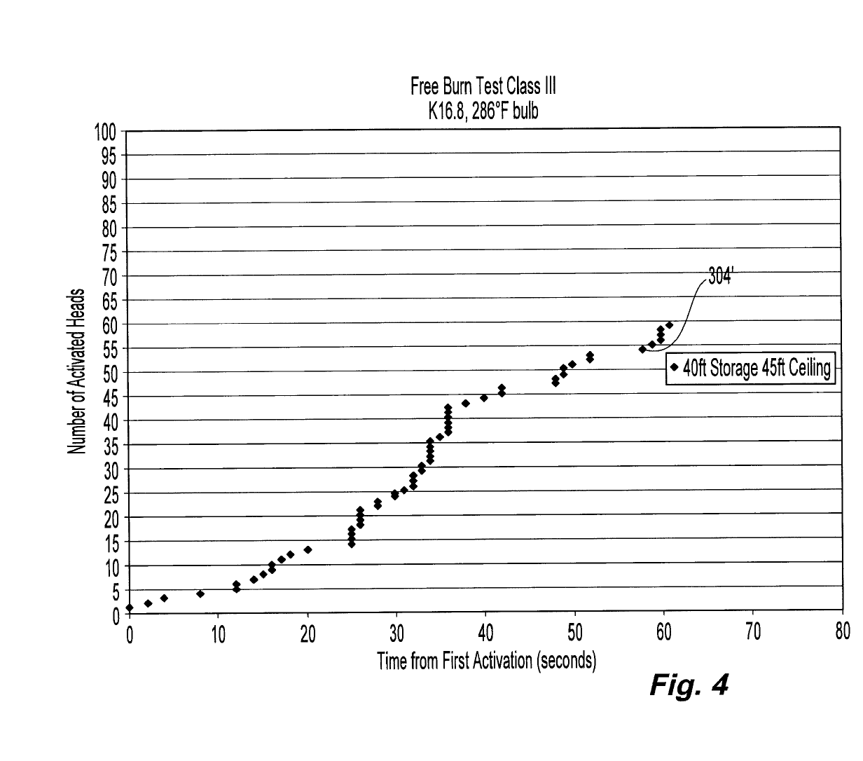

The sprinkler activations in the free-burn test could be monitored, counted, plotted along a time line and accordingly sequenced. A sample free-burn plot is provide in FIG. 4. From the free-burn sprinkler activation plot, one can identify the time at which the number of activated sprinklers equaled the number of activations forming the IDA, and thereby identify the CBT in the free burn test. Accordingly, a smaller lapse of time than that required to reach the equivalent IDA can be preferably selected to further identify a maximum fluid delivery delay period for implementation in the dry sprinkler system. The selected maximum fluid delivery delay period would form an initial sprinkler operating area smaller than the IDA. Provided fluid is delivered to the initial sprinkler operating area and preferably discharged at designed operating pressure, the design dry sprinkler system will presumably thermally activate a subsequent group of sprinklers to form a final sprinkler operating area preferably equivalent in size to the IDA. Accordingly, the final sprinkler operation area of the dry system would address a fire event in an equivalent manner to the wet system. Regardless of whether the operation sequence is identified with a computational or an empirical approach, a range of fluid delivery delay periods is preferably identified having a maximum fluid delivery delay period and a minimum fluid delivery delay period in which to discharge fluid, preferably at designed operating discharge pressure for the formation of the equivalent IDA.

In one preferred illustrative embodiment of the design method 100, a dry sprinkler system 10′ and a stored commodity 50′ beneath the system 10′ were modeled using the computational or predictive modeling approach 200 as described above. The modeling parameters included Group A plastic commodity in a double-row rack arrangement stored to a height of about thirty feet (30 ft.) located in a storage area having a ceiling height of about thirty-five feet (35 ft.). The dry sprinkler system 10′ included one hundred 16.8 K-factor upright specific application storage sprinklers having a nominal RTI of 190 (ft-sec)^{1/2} and a thermal rating of 286° F. on ten-by-ten foot (10 ft.×10 ft.) spacing. The sprinkler system was located about seven inches (7 in.) beneath the ceiling.

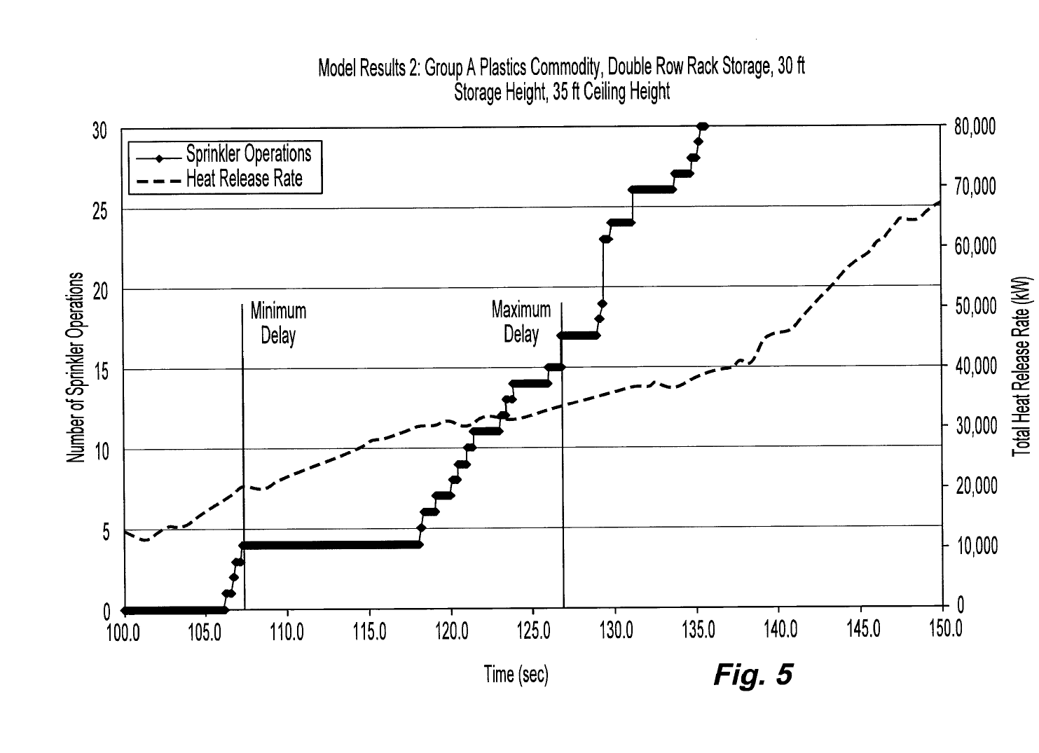

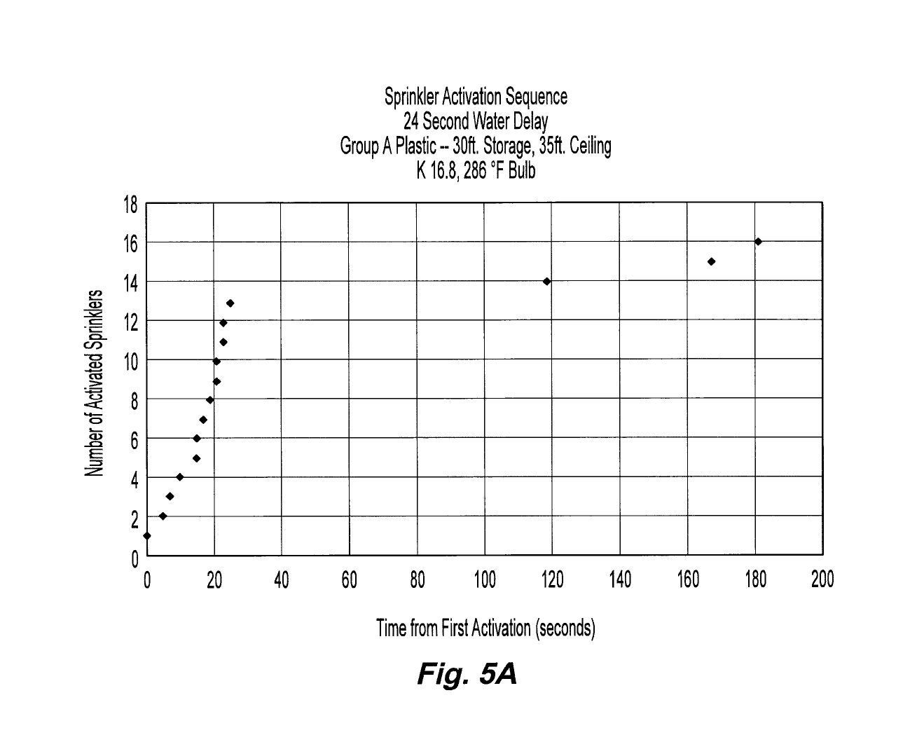

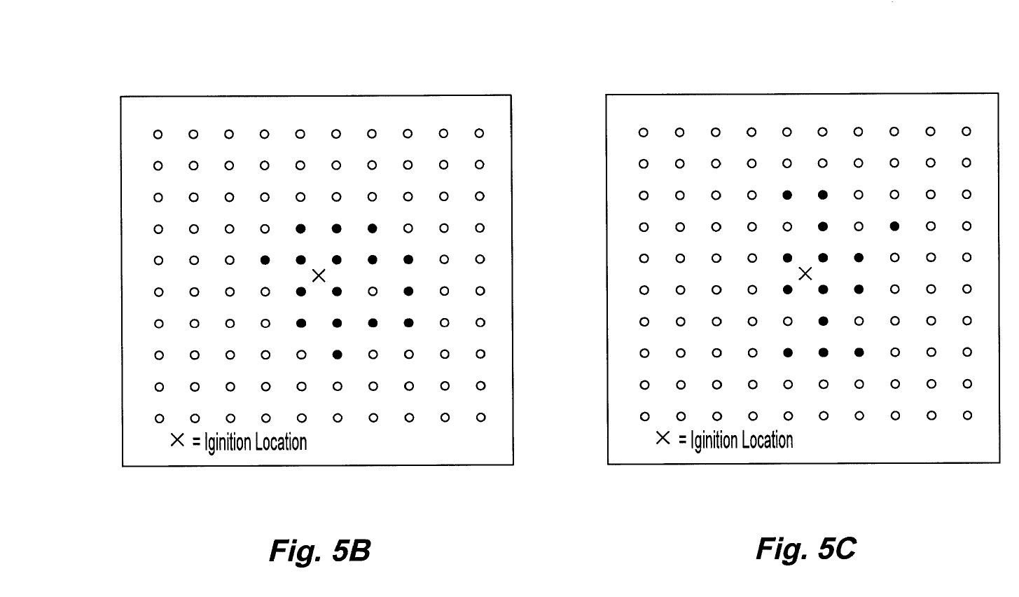

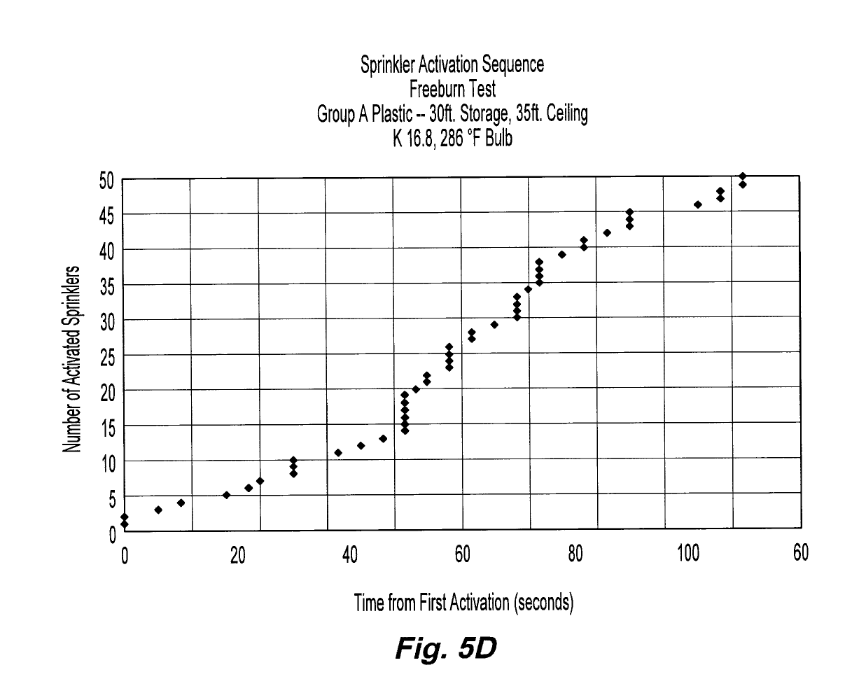

The system 10′ was modeled to develop the predictive heat release and sprinkler activation profile as seen in FIG. 5. From the predictive profile, a delivery delay period was identified having a maximum fluid delivery delay period of about twenty-four seconds (24 sec.) and a minimum fluid delivery delay period of about two seconds (2 sec.) for the given ceiling height H1 of thirty-five feet (35 ft.). The first sprinkler activation was predicted to occur at about one minute and forty-six seconds (1:46 min-sec.) after ignition. A fluid delivery delay period of thirty seconds (24 s.) was selected from the range between the maximum and minimum fluid delivery delay periods for testing.

The modeled sprinkler system 10′ for the protection of Group A plastic storage commodity was constructed as a test plant. The test plant room measured 120 ft.×120 ft. and 54 ft. high. The test plant included a 100 ft.×100 ft. adjustable height ceiling which permitted the ceiling height of the plant to be variably set.

In the test plant, the main commodity array 50′ and its geometric center was stored beneath four sprinklers in an off-set configuration. More specifically, the main array 50 of Group A plastic commodity was stored upon industrial racks utilizing steel upright and steel beam construction. The 32 ft. long by 3 ft. wide rack members were arranged to provide a double-row main rack with four 8 ft. bays. Beam tops were positioned in the racks at vertical tier heights of 5 ft. increments above the floor. A single-row target array 52′ was spaced at a distance of eight feet (8 ft.) from the main array 50′. Another single-row target array (not shown) of the same configuration was disposed at the same distance on the other side of the main array 50′. The target arrays 52′ consisted of industrial, single-row rack utilizing steel upright and steel beam construction. The 24 ft. long by 3 ft. wide rack system was arranged to provide a single-row target rack with three 8 ft. bays. The beam tops of the rack of the target array 52′ were positioned on the floor and at 5 ft. increments above the floor. The bays of the main array 50′ were loaded to provide a nominal six inch longitudinal and transverse flue space throughout the array. The main and target array racks were approximately twenty-eight feet (28 ft.) tall and consisted of six vertical bays.

The Group A plastic commodity was constructed from rigid crystalline polystyrene cups packaged in compartmented in single wall, corrugated cardboard cartons. To form the compartments, single wall corrugated cardboard sheets separated five layers and vertical columns of each layer. In this particular arrangement, eight twenty-one inch (21 in.) cube cartons arranged 2×2×2 form a pallet load. Each pallet weighed approximately about 165 lbs of which about 40% is plastic. The overall storage height was 29 ft.-10 in. (nominally 30 ft.), and the movable ceiling was set to 35 ft.

An actual fire test was conducted to verify the ability of the system 10′ to address a fire growth in the Group A plastic storage commodity. The fire was initiated twenty-one inches off-center from the center of the main array 50 and the test was run for a test period T of thirty-two minutes (32 min). The ignition source were two half-standard cellulose cotton igniters. The igniters were constructed from a three inch by three inch (3 in×3 in) long cellulose bundle soaked with 4-oz. of gasoline and wrapped in a polyethylene bag. Following thermal activation of the first sprinkler in the system 10, fluid delivery and discharge was delayed for the selected period of twenty-four seconds (24 sec.). The delay was implemented by way of a solenoid valve located after the primary water control valve. The Dry System Summary table below provides a summary table of both the model and test parameters. In addition Table 1 provides the predicted sprinkler operational area and fluid delivery delay period next to the measured results from the test.

Dry System Summary Table

| | |
|---|---|
| MODEL | TEST |

PARAMETERS

| Storage Type | Double Row Rack | | Double Row Rack | |
|---|---|---|---|---|
| Commodity Type | Group A | | Group A | |
| Nominal Storage Height (H2) | 30 | ft. | 30 | ft. |
| Nominal Ceiling Height (H1) | 35 | ft. | 35 | ft. |
| Nominal Clearance (L) | 5 | ft | 5 | ft |
| Ignition Location | Under 4, Offset | | Under 4, Offset | |
| Temperature Rating ° F. | 286 | | 286 | |
| Nominal 5 mm. Glass Bulb - Response Time Index (ft-sec)^{1/2} | 190 | | 190 | |
| Deflector to Ceiling (S) | 7 | in | 7 | in |
| Nominal Sprinkler Discharge Coefficient K (gpm/psi^{1/2}) | 16.8 | | 16.8 | |
| Nominal Discharge Pressure (psi) | 35 | | 35 | |
| Nominal Discharge Density (gpm/ft²) | 1.0 | | 1.0 | |
| Aisle Width (W) | 8 | ft | 8 | ft |

| Sprinkler Spacing (ft × ft) | 10 × 10 | | 10 × 10 |
|---|---|---|---|
| Selected Fluid Delivery Delay Period (Δt) | 24 | sec. | |

| | | | |
|---|---|---|---|
| Fluid delivery Delay Period (Δt) | — | 24 | sec |

RESULTS

| | | |
|---|---|---|
| Length of Test (min:s) | 30:00 | 32:00 |
| First Ceiling Sprinkler Operation (min:s) | 1:46 | 1:53 |
| Water to Sprinklers (min:s) | — | 2:09 |
| Number of Sprinklers at Time of Fluid delivery (16 sec.) | — | 6 |
| Number of Sprinklers Activated 16 sec. After First Activation | Approx. 11 | — |
| Last Ceiling Sprinkler Operation (min:s) | — | 4:54 |
| System Pressure at 35 psi | — | 2:17 |
| Number of Operated Ceiling Sprinklers at Time of System Pressure | — | 12 |
| Number of Sprinklers Activated 24 sec. After First Activation | Approx. 19 | — |
| Peak Gas Temperature at Ceiling Above Ignition ° F. | — | 1654 |
| Maximum 1 Minute Average Gas Temperature at Ceiling Above Ignition ° F. | — | 975 |
| Peak Steel Temperature at Ceiling Above Ignition ° F. | — | 448 |
| Maximum 1 Minute Average Steel Temperature Above Ignition ° F. | — | 337 |
| Fire Spread Across Aisle | — | Yes |
| Fire Spread Beyond Extremities | | No |

The test results verify that a specified ADT of twenty-four seconds (24 sec.) can activate a set of sprinklers in a dry sprinkler system to form a sprinkler operational area to control a fire growth in the Group A plastics storage configuration. More specifically, the predictive sprinkler activation profile identified a fire growth resulting in about nineteen (19) sprinkler activations, as shown in FIG. 5, immediately following the twenty-four second fluid delivery delay period. In the actual fire test, six (6) sprinkler activations resulted following the first sixteen seconds (16 sec.), at which point fluid reached the actuated sprinklers. The model predicted for the same sixteen second period a total of eleven (11) sprinkler heads actuated. System design pressure was achieved eight seconds later at which time twelve (12) sprinklers were activated. According to the model, twenty-four seconds (24 sec.) after the first sprinkler activation, nineteen (19) sprinkler actuated. Again, it should be noted that the model does not capture the effects of fluid introduction or compression time, i.e. the time between the sixteenth and twenty-fourth second. In the actual dry system test, four additional sprinklers were actuated to bring the total number of sprinkler activations to sixteen for the entire test period.

The test results show that a correctly predicted fluid delivery delay resulted in the formation of a sprinkler operational area made up of twelve activated sprinklers which effectively controlled the fire. Moreover, the last thermal activation of a sprinkler (the 16^{th} sprinkler operation) occurred in just under five minutes (5 min.) from the moment of ignition and no additional sprinkler activations occurred for the next twenty-seven minutes (27 min.) of the test period. Additional features of dry sprinkler system 10 performance were observed such as, for example, the extent of the damage to the commodity or the behavior of the fire relative to the storage. For the test summarized in the table above, it was observed that the fire and damage did not spread beyond the extremities of the commodity.

Shown in FIG. 5B is a graphical plot of the sprinkler activations indicating the location of each actuated sprinkler relative to the ignition locus. The graphical plot provides an indicator of the amount of sprinkler skipping, if any. More specifically, the plot graphically shows the concentric rings of sprinkler activations proximate the ignition locus, and the location of unactuated sprinklers within one or more rings to indicate a sprinkler skip. According to the plots of FIGS. 5A and 5B corresponding to summary table above, there was no skipping. The table below provides the sprinkler activation sequence and times relative to the first sprinkler activation for the dry system test.

Dry System Sprinkler Activation Sequence

| | Activation Time After |
|---|---|
| Sprinkler | First Sprinkler |
| Sequence | Activation (Sec.) |
| 1 | 0 |
| 2 | 5 |
| 3 | 7 |
| 4 | 10 |
| 5 | 15 |
| 6 | 15 |
| 7 | 17 |
| 8 | 19 |
| 9 | 21 |
| 10 | 21 |
| 11 | 23 |
| 12 | 23 |
| 13 | 25 |
| 14 | 119 |
| 15 | 167 |
| 16 | 181 |

To verify that the selected ADT of twenty-four seconds would produce a sprinkler operational area substantially equal to or less than the IDA of a wet system configured to protect the same storage configuration, the system 10′ was charged as a wet system 10″ and a wet system test was conducted to determine the IDA. To further verify the accuracy of the computational model used to generate the predictive profile of FIG. 5A, the system 10′ was configured in a free burn test in which water was delivered after more than fifty sprinkler activations. The summary table below provides a summary of the wet system and free burn test results.

Wet System & Free Burn Test Summary

| | |
|---|---|
| WET SYSTEM | FREE BURN |
| TEST | TEST |

PARAMETERS

| Storage Type | Double Row Rack | | Double Row Rack | |
|---|---|---|---|---|
| Commodity Type | Group A | | Group A | |
| Nominal Storage Height (H2) | 30 | ft. | 30 | ft. |
| Nominal Ceiling Height (H1) | 35 | ft. | 35 | ft. |
| Nominal Clearance (L) | 5 | ft | 5 | ft |
| Ignition Location | Under 4, Offset | | Under 4, Offset | |
| Temperature Rating ° F. | 286 | | 286 | |
| Nominal 5 mm. Glass Bulb - Response Time Index (ft-sec)^{1/2} | 190 | | 190 | |
| Deflector to Ceiling (S) | 7 | in | 7 | in |
| Nominal Sprinkler Discharge Coefficient K (gpm/psi^{1/2}) | 16.8 | | 16.8 | |
| Nominal Discharge Pressure (psi) | 35 | | 35 | |
| Nominal Discharge Density (gpm/ft²) | 1.0 | | 1.0 | |
| Aisle Width (W) | 8 | ft | 8 | ft |

| Sprinkler Spacing (ft × ft) | 10 × 10 | 10 × 10 | |
|---|---|---|---|
| Fluid delivery Delay Period (Δt) | N/A | 24 | sec |

RESULTS

| | | |
|---|---|---|
| Length of Test (min:s) | 30:00 | 7:30 |
| First Ceiling Sprinkler Operation (min:s) | 1:32 | 1:53 |
| Water to Sprinklers (min:s) | — | 3:01 |
| Number of Sprinklers at Time of Fluid delivery | 14 | 50+ |
| Last Ceiling Sprinkler Operation (min:s) | 14:41 | 3:08 |
| System Pressure at 35 psi | — | 3:20 |
| Total Number of Operated Ceiling Sprinklers | 14 | 90+ |
| Peak Gas Temperature at Ceiling Above Ignition ° F. | 1328 | 1893 |
| Maximum 1 Minute Average Gas Temperature at Ceiling Above Ignition ° F. | 1000 | 1634 |
| Peak Steel Temperature at Ceiling Above Ignition ° F. | 282 | 900 |
| Maximum 1 Minute Average Steel Temperature Above Ignition ° F. | 234 | 831 |
| Fire Spread Across Aisle | Yes | Yes |
| Fire Spread Beyond Extremities | Yes | Yes |

According to the sprinkler activation plot at FIG. 5C, the wet system test resulted in a total of fourteen (14) sprinkler activations to define the IDA of the wet system. The table below provides the sprinkler activation sequence and times relative to the first sprinkler activation for the wet system test.

Wet System Sprinkler Activation Sequence

| | Activation Time After |
|---|---|
| Sprinkler | First Sprinkler |
| Sequence | Activation (Sec.) |
| 1 | 0 |
| 2 | 2 |
| 3 | 18 |
| 4 | 29 |
| 5 | 135 |
| 6 | 135 |
| 7 | 135 |
| 8 | 137 |
| 9 | 138 |
| 10 | 146 |
| 11 | 146 |
| 12 | 203 |
| 13 | 274 |
| 14 | 796 |

Accordingly, the wet system supported the selection of a twenty-four second ADT in the dry system to define a dry system sprinkler operational area of about twelve sprinklers. The free burn test shows that fourteen (14) sprinkler activations occurs at about twenty-five seconds (25 sec.) after the first sprinkler activation to define the CBT for the sprinkler system and storage configuration. Accordingly, the free burn test results support identification the selected twenty-four second ADT under the computational approach. The above dry system, wet system and free burn tests are further described in UL test report, “Fire Performance Evaluation of Dry-Pipe Sprinkler Systems For Protection of Group A Unexpanded Plastic Commodity Using K-16.8 Sprinkler: Technical Report Underwriters Laboratories Inc. Project 06NK25315, EX4991 For Tyco Fire & Building Products Mar. 13, 2007.”

Referring again to FIG. 2, another aspect of the preferred design methodology provides a configuration step 110 to implement the selected fluid delivery delay period into the dry system. Preferably, the dry sprinkler system is configured such that each sprinkler in the dry system experiences a fluid delivery delay period that provides for formation of a sprinkler operating area effectively equivalent to the IDA of an appropriately configured wet system. More preferably, a selected fluid delivery delay identified from the sprinkler operating sequence is implemented in the dry sprinkler system by constructing the system with piping of a determined length and cross-sectional area and/or providing the necessary fluid control devices downstream of the primary control valve such that each sprinkler in the dry system experiences a fluid delivery delay period equal to or less than the selected fluid delivery delay period.

A designer or constructor of a dry sprinkler system can physically build a system and modify the system to implement the desired fluid delivery delay period by changing, for example, pipe lengths or introducing other devices to achieve the designed fluid delivery delays for each sprinkler on the circuit. The system can then be tested by activating any sprinkler in the system and determining whether the fluid delivery from the primary water control valve to the test sprinkler is within the selected fluid delivery delay periods or ADT. Alternatively, incorporation of a preferred fluid delivery delay into the design and construction of the dry sprinkler system can be an iterative design process by which the a system is dynamically modeled to determine if the sprinklers within the system experiences a fluid delivery delay that falls within an acceptable delay range from the identifying step 108 of the design process. Preferably, the dry sprinkler system is mathematically modeled so as to include one or more activated sprinklers. The model can further characterize the flow of liquid and gas through the system over time following an event which triggers a trip of the primary water control valve. The water discharge times from the model can be evaluated to determine system compliance with the mandatory fluid delivery times. Moreover, the modeled system can be altered and the liquid discharge characteristics can be repeatedly solved to evaluate changes to the system and bring the system into compliance with the desired fluid delivery delay period. To facilitate modeling of the dry sprinkler system and to solve for the liquid discharge times and characteristics, a user can utilize computational software capable of building and solving for the hydraulic performance of the sprinkler.

More specifically, a dry pipe sprinkler system for protection of a stored commodity can be modeled so as to capture the pipe characteristics, pipe fittings, liquid source, risers, and sprinklers while accounting for the preferred fluid delivery delay period. The model can further include changes in pipe elevations, pipe branching, accelerators, or other fluid control devices. The dynamic model can, based upon sprinkler activation and piping configurations, simulate the water travel through the system for a given fluid static pressure to determine if the desired fluid delivery delay period is satisfied. If water discharge fails to occur as predicted, the model can be modified accordingly to deliver water within the requirements of the fluid delivery delay. For example, piping in the modeled system can be shortened or lengthened in order that fluid is discharged at the expiration of the fluid delivery delay period at the desired designed operating discharge pressure. Alternatively, the designed pipe system can include a pump to comply with the fluid delivery requirements. In one aspect, the model can be designed and simulated to determine if the fluid delivery is effectively equivalent to that of the IDA in the wet system. Accordingly, the model and simulation of the sprinkler system can verify that the fluid delivery to each sprinkler in the system falls within the range of the selected fluid delivery delay period. Dynamic modeling and simulation of a sprinkler system permits iterative design techniques to be used to bring sprinkler system performance in compliance with design criteria rather than relying on after construction modifications of physical plants to correct for non-compliance with design specifications.

Alternatively or additionally, instead of constructing a new sprinkler system an existing wet and/or dry sprinkler systems can be retrofitted to employ a fluid delivery delay period to achieve a sprinkler operational area that is effectively the equivalent of the IDA in an appropriately configured wet system. For existing wet systems, a conversion to the preferred dry system can be accomplished by inclusion of a primary water control valve and necessary components to ensure fluid delivery is appropriately delayed to one or more initially thermally activated sprinklers and subsequently discharged at the desired operating pressure so as to finally form the equivalent IDA. Furthermore, those of skill can take advantage of the methods of optimizing sprinkler operating area to modify existing dry systems to produce the equivalent IDA effect. In particular, components such as, for example, accumulators or mechanical and/or electronic programmable accelerators can be added to existing dry sprinkler systems to ensure that each sprinkler experiences a fluid delivery delay period that promotes the timely formation of the equivalent IDA. The inventor believes an existing wet or dry sprinkler system reconfigured to achieve substantially the equivalent hydraulic performance of a wet system can eliminate or otherwise minimize the economic disadvantages of current sprinkler systems. In particular, the preferred method can eliminate the need to oversize the hydraulic design of the dry system or eliminate the need for in-rack sprinklers as is required in accordance with NFPA standards.

The preferred design methodology can be more specifically used to design a preferred hydraulic design area for the system 10. The hydraulic design area is preferably configured so as to include the most hydraulically remote sprinkler in the plurality of sprinklers 20. In accordance with the design methodology described above, the design area preferably corresponds to the IDA of an appropriately configured wet sprinkler system protecting the equivalent storage occupancy. More preferably, the design area is no greater than the design areas provided in NFPA-13 for wet sprinkler systems. The preferred methodology 100 accordingly identifies design criteria: a preferred hydraulic design area and a desired fluid delivery delay period. Preferably, all the sprinklers experience a fluid delivery delay period within the selected fluid delivery delay period or ADT. Alternatively, however, the system 10 can be configured such that one or a selected few of the sprinklers 20 are configured with a fluid delivery delay period which provides for the thermal activation of a number of sprinklers surrounding each of the select sprinklers to form a sprinkler operational area effectively the equivalent of the IDA.

A dry sprinkler system 10 having a fluid delivery delay period to support fire control can be mathematically modeled so as to include one or more activated sprinklers. The model can further characterize the flow of liquid and gas through the system 10 over time following an event which triggers a trip of the primary water control valve. The mathematical model can be utilized to solve for the liquid discharge pressures and discharge times from any activated sprinkler. The water discharge times from the model can be evaluated to determine system compliance with the selected fluid delivery delay period. Moreover, the modeled system can be altered and the liquid discharge characteristics can be repeatedly solved to evaluate changes to the system 10 and to bring the system into compliance with the design criteria of the desired fluid delivery delay period so as to effect the desired IDA. To facilitate modeling of the dry sprinkler system 10 and to solve for the liquid discharge times and characteristics, a user can utilize computational software capable of building and solving for the hydraulic performance of the sprinkler 10.

A dry pipe sprinkler system 10 for protection of a stored commodity can be modeled so as to capture the pipe characteristics, pipe fittings, liquid source, risers, sprinklers and various tree-type or branching configurations while accounting for the preferred hydraulic design area and fluid delivery delay period. The model can further include changes in pipe elevations, pipe branching, accelerators, or other fluid control devices. The designed dry sprinkler system can be mathematically and dynamically modeled to capture and simulate the design criteria, including the preferred the selected fluid delivery delay period. The fluid delivery delay period can be solved and simulated using a computer program described, for example, in U.S. patent application Ser. No. 10/942,817 filed Sep. 17, 2004, published as U.S. Patent Publication No. 2005/0216242, and entitled “System and Method For Evaluation of Fluid Flow in a Piping System,” which is incorporated by reference in its entirety. To model a sprinkler system in accordance with the design criteria, another software program can be used that is capable of sequencing sprinkler activations and simulating fluid delivery to effectively model formation and performance of the preferred sprinkler operational area. Such a software application is described in PCT International Patent Application filed on Oct. 3, 2006 entitled, “System and Method For Evaluation of Fluid Flow in a Piping System,” having PCT Application No. PCT/US06/38360, claiming priority to U.S. Provisional Patent Application 60/722,401 filed on Oct. 3, 2005 and which is incorporated by reference in its entirety. Described therein is a computer program and its underlying algorithm and computational engines that performs sprinkler system design, sprinkler sequencing and simulates fluid delivery. Accordingly, such a computer program can design and dynamically model a sprinkler system for fire protection of a given commodity in a given storage area. The designed and modeled sprinkler system can further simulate and sequence of sprinkler activations in accordance with a time-based predictive sprinkler activation profile, as discussed above, to dynamically model the system 10. The preferred software application/computer program is also shown and described in the user manual entitled “SprinkFDT™ SprinkCALC™: SprinkCAD Studio User Manual” (September 2006).

The dynamic model can preferably simulate the water travel through the system 10 at a specified pressure to determine if the selected hydraulic design criteria and fluid delivery delay criteria are satisfied. If water discharge fails to occur as predicted, the model can be modified accordingly to deliver water within the requirements of the preferred hydraulic design area and the mandatory fluid delivery periods. For example, piping in the modeled system can be shortened or lengthened in order that water is discharged at the expiration of the fluid delivery delay period. Alternatively, the designed pipe system can include a pump to comply with the fluid delivery requirements. In one aspect, the model can be designed and simulated with sprinkler activation at the most hydraulically remote sprinkler to determine if fluid delivery complies with an appropriately identified ADT. Moreover, the simulated system can provide for sequencing the thermal activations of preferably the four most hydraulically remote sprinklers to solve for a simulated fluid delivery delay period. Alternatively, the model can be simulated with activation at the most hydraulically close sprinkler to determine if fluid delivery complies with a minimum fluid delivery delay period. Again moreover, the simulated system can provide for sequencing the thermal activations of preferably the four most hydraulically close sprinklers to solve for a simulated fluid delivery delay period. Accordingly, the model and simulation of the sprinkler system can verify that the fluid delivery to each sprinkler in the system falls within the selected range of the maximum and minimum fluid delivery delay period. Dynamic modeling and simulation of a sprinkler system permits iterative design techniques to be used to bring sprinkler system performance in compliance with design criteria rather than relying on after construction modifications of physical plants to correct for non-compliance with design specifications.

A model can be constructed to define a dry sprinkler system 10 as a network of sprinklers and piping. The grid spacing between sprinklers and branch lines of the system can be specified, for example, 12 ft. by 8 ft, 10 ft. by 10 ft., 10 ft. by 8 ft., or 8 ft. by 8 ft. between sprinklers. The system can be modeled to incorporate specific sprinklers such as, for example, 16.8 K-factor 286° F. upright sprinklers having a specific application for storage such as the ULTRA K17 sprinkler provided by Tyco Fire and Building Products and shown and described in TFP331 data sheet entitled “Ultra K17-16.8 K-factor: Upright Specific Application Control Mode Sprinkler Standard Response, 286° F./141° C.” (March 2006) or which is incorporated in its entirety by reference. However, any suitable sprinkler could be used provided the sprinkler can provide sufficient fluid volume and cooling effect to at least control a fire. More specifically, the suitable sprinkler provides a satisfactory fluid discharge volume, fluid discharge velocity vector (direction and magnitude) and fluid droplet size distribution. Examples of other suitable sprinklers include, but are not limited to the following sprinklers provided by Tyco Fire & Building Products: the SERIES ELO-231-11.2 K-Factor upright and pendant sprinklers, standard response, standard coverage (data sheet TFP340 (January 2005)); the MODEL K17-231-16.8 K-Factor upright and pendant sprinklers, standard response, standard coverage (data sheet TFP332 (January 2005)); the MODEL EC-25-25.2 K-Factor extended coverage area density upright sprinklers (data sheet TFP213 (September 2004)); models ESFR-25-25.2 K-factor (data sheet TFP312 (January 2005), ESFR-17-16.8 K-factor (data sheet TFP315 (January 2005)) (data sheet TFP316 (April 2004)), and ESFR-1-14.0 K-factor (data sheet TFP318 (July 2004)) early suppression fast response upright and pendant sprinklers, each of which is shown and described in its respective data sheets which are incorporated by reference in their entirety. In addition, the dry sprinkler system model can incorporate a water supply or “wet portion” of the system connected to the dry portion of the dry sprinkler system 10. The modeled wet portion can include the devices of a primary water control valve, backflow preventer, fire pump, valves and associated piping. The dry sprinkler system can be further configured as a tree or tree with a loop system.

From the preferred design methodology, a model of the dry sprinkler system 10 can simulate formation of a sprinkler operational area 26 effectively the equivalent to the IDA of an appropriately configured wet system. The sprinkler activations can be sequenced according to user defined parameters such as, for example, a sequence that follows the predicted sprinkler activation profile. The model can further incorporate the preferred fluid delivery delay period by simulating fluid and gas travel through the system 10 and out from the activated sprinklers defining the resultant sprinkler operational area. The modeled fluid delivery times can be compared to the specified mandatory fluid delivery delay periods and the system can be adjusted accordingly such that the fluid delivery times are in compliance with the mandatory fluid delivery delay period. From a properly modeled and compliant system 10, an actual dry sprinkler system 10 can be constructed.

The preferred design methodology 100 can provide for further methodologies for implementing such a system 10. Various systems, subsystems and processes are now available for providing fire protection components, systems, design approaches and applications, preferably for storage occupancies, to one or more parties such as intermediary or end users such as, for example, fire protection manufacturers, suppliers, contractors, installers, building owners and/or lessees. For example, a process can be provided for a method of a dry sprinkler fire protection system that utilizes the preferred design methodology 100. Additionally or alternatively provided can be a sprinkler qualified for use in such a system. Offerings of fire protections systems incorporating the preferred design methodology 100 can be further embodied in design and business-to-business applications for fire protection products and services.

In an illustrative aspect of providing a device and method of fire protection, a sprinkler is preferably obtained for use in a preferred dry sprinkler fire protection system for the protection of a storage occupancy. More specifically, preferably obtained is a sprinkler 20 qualified for use in a dry sprinkler fire protection system for a storage occupancy over a range of available ceiling heights H1 for the protection of a stored commodity 50 having a range of classifications and range of storage heights H2. More preferably, the sprinkler 20 is listed by an organization approved by an authority having jurisdiction such as, for example, NFPA or UL for use in a dry, preferably ceiling-only, fire sprinkler protection system for fire protection of, for example, any one of a Class I, II, III and IV commodity ranging in storage height from about twenty feet to about forty feet (20-40 ft.) or alternatively, a Group A plastic commodity having a storage height of up to about thirty feet. Even more preferably, the sprinkler 20 is qualified for use in a dry sprinkler protection system, such as sprinkler system 10 described above, configured with an appropriately selected fluid delivery delay period or ADT.

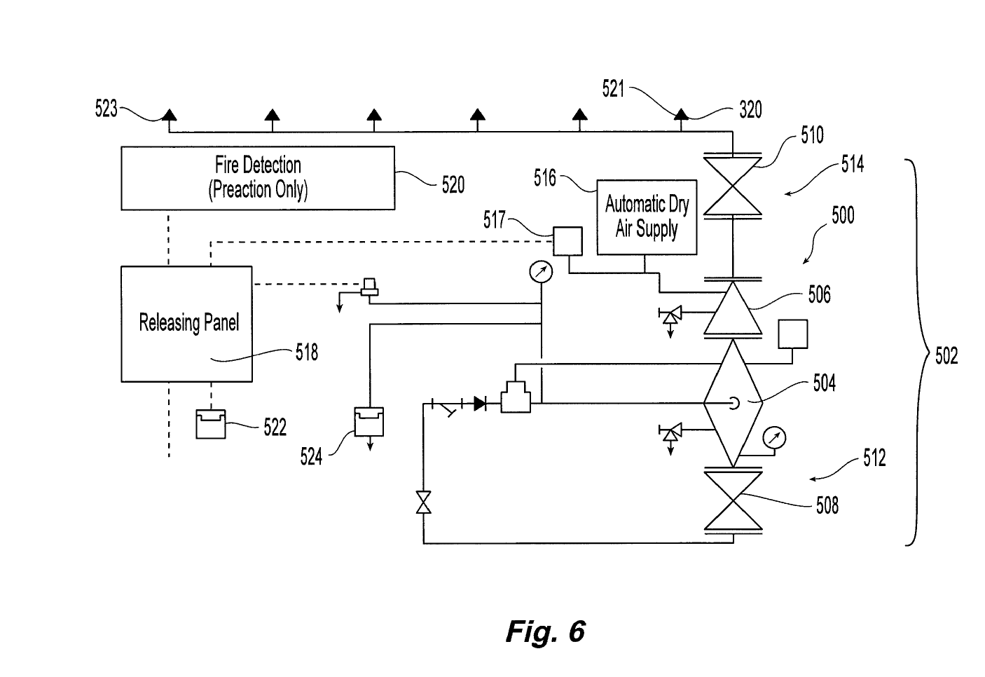

In one aspect of the systems and methods of fire protection, a preferred sprinkler can be embodied, obtained and/or packaged in a preferred dry sprinkler protection system 500 for use in fire protection of a storage occupancy. As seen for example, in FIG. 6, shown schematically is the system 500 for protection of a storage occupancy that employs the preferred design methodology described above. Preferably, the system 500 includes a riser assembly 502 to provide controlled communication between a fluid or wet portion 512 the system 500 and the preferably dry portion of the system 514.

The riser assembly 502 preferably includes a control valve 504 for controlling fluid delivery between the wet portion 512 and the dry portion 514. More specifically, the control valve 504 includes an inlet for receiving the fire fighting fluid from the wet portion 512 and further includes an outlet for the discharge of the fluid. Preferably, the control valve 504 is a solenoid actuated deluge valve actuated by solenoid 505, but other types of control valves can be utilized such as, for example, mechanically or electrically latched control valves. Further in the alternative, the control valve 504 can be an air-over-water ratio control valve, for example, as shown and described in U.S. Pat. No. 6,557,645 which is incorporated in its entirety by reference. One type of preferred control valve is the MODEL DV-5 DELUGE VALVE from Tyco Fire & Building Products, shown and described in the Tyco data sheet TFP1305, entitled, “Model DV-5 Deluge Valve, Diaphragm Style, 1½ thru 8 Inch (DN40 thru DN200, 250 psi (17.2 bar) Vertical or Horizontal Installation” (March 2006), which is incorporated herein in its entirety by reference. Adjacent the outlet of the control valve is preferably disposed a check-valve to provide an intermediate area or chamber open to atmospheric pressure. To isolate the deluge valve 504, the riser assembly further preferably includes two isolating valves disposed about the deluge valve 504. Other diaphragm control valves 504 that can be used in the riser assembly 502 are shown and described in U.S. Pat. Nos. 6,095,484 and 7,059,578 and U.S. patent application Ser. No. 11/450,891. In an alternative configuration, the riser assembly or control valve 504 can include a modified diaphragm style control valve so as to include a separate chamber, i.e. a neutral chamber, to define an air or gas seat thereby eliminating the need for the separate check valve.

The dry portion 514 of the system 500 preferably includes a network of pipes having a main and one or more branch pipes extending from the main for disposal above a stored commodity. The dry portion 514 of the system 500 is further preferably maintained in its dry state by a pressurized air source 516 coupled to the dry portion 514. Spaced along the branch pipes are the sprinklers qualified for protection in the storage occupancy, such as for example, the preferred sprinkler 320. Preferably, the network of pipes and sprinklers are disposed above the commodity so as to define a minimum sprinkler-to-storage clearance and more preferably a deflector-to-storage clearance of about thirty-six inches. Wherein the sprinklers 320 are upright sprinklers, the sprinklers 320 are preferably mounted relative to the ceiling such that the sprinklers define a deflector-to-ceiling distance of about seven inches (7 in.). Alternatively, the deflector-to-ceiling distance can be based upon known deflector-to-ceiling spacings for existing sprinklers, such as large drop sprinklers as provided by Tyco Fire & Building Products.

The dry portion 514 can include one or more cross mains so as to define either a tree configuration or more preferably a loop configuration. The dry portion is preferably configured with a hydraulic design area defined by an IDA of an appropriately configured wet system. The sprinkler-to-sprinkler spacing can range from a minimum of about eight feet to a maximum of about 12 feet for unobstructed construction, and is more preferably about ten feet for obstructed construction. Accordingly, the dry portion 514 can be configured with a hydraulic design area less than current dry fire protection systems specified under NFPA 13 (2002). Preferably, the dry portion 514 is configured so as to define a coverage area on a per sprinkler bases ranging from about eighty square feet (80 ft.²) to about one hundred square feet (100 ft.²).

The fluid delivery from the wet portion 512 to the dry portion 514 is controlled by actuation of the control valve 506. To control actuation of the control valve, the system 500 preferably includes a releasing control panel 518 to energize the solenoid valve 505 to operate the solenoid valve. Alternatively, the control valve can be controlled, wired or otherwise configured such that the control valve is normally closed by an energized solenoid valve and accordingly actuated open by de-energizing signal to the solenoid valve. The system 500 can be configured as a dry preaction system and is more preferably configured as a double-interlock preaction system based upon in-part, a detection of a drop in air pressure in the dry portion 514. To ensure that the solenoid valve 505 is appropriately energized in response to a loss in pressure, the system 500 further preferably includes an accelerator device 517 to reduce the operating time of the control valve in a preaction system. The accelerator device 517 is preferably configured to detect a small rate of decay in the air pressure of the dry portion 514 to signal the releasing panel 518 to energize the solenoid valve 505. Moreover the accelerator device 517 can be a programmable device to program and effect an adequate minimum fluid delivery delay period. One preferred embodiment of the accelerator device is the Model QRS Electronic Accelerator from Tyco Fire & Building Products as shown and described in Tyco data sheet TFP 1100 entitled, “Model QRS Electronic Accelerator (Quick Opening Device) For Dry Pipe or Preaction Systems” (May 2006). Other accelerating devices can be utilized provided that the accelerator device is compatible with the pressurized source and/or the releasing control panel when employed.

Where the system 500 is preferably configured as a dry double-interlock preaction system, the releasing control panel 518 can be configured for communication with one or more fire detectors 520 to inter-lock the panel 518 in energizing the solenoid valve 505 to actuate the control valve 504. Accordingly, one or more fire detectors 520 are preferably spaced from the sprinklers 320 throughout the storage occupancy such that the fire detectors operate before the sprinklers in the event of a fire. The detectors 520 can be any one of smoke, heat or any other type capable to detect the presence of a fire provided the detector 520 can generate signal for use by the releasing control panel 518 to energize the solenoid valve to operate the control valve 504. The system can include additional manual mechanical or electrical pull stations 522, 524 capable of setting conditions at the panel 518 to actuate the solenoid valve 505 and operate the control valve 504 for the delivery of fluid. Accordingly, the control panel 518 is configured as a device capable of receiving sensor information, data, or signals regarding the system 500 and/or the storage occupancy which it processes via relays, control logic, a control processing unit or other control module to send an actuating signal to operate the control valve 504 such as, for example, energize the solenoid valve 505.

In connection with providing a preferred sprinkler for use in a dry sprinkler fire protection system or alternatively in providing the system itself, the preferred device, system or method of use further provides design criteria for configuring the sprinkler and/or systems to effect a sprinkler operational area equivalent to the IDA of an correspondingly appropriately configured wet system. A preferred dry sprinkler system configured with a preferred fluid delivery delay period, such as for example, system 500 described above includes a sprinkler arrangement relative to a riser assembly to define one or more most hydraulically remote or demanding sprinklers 521 and further define one or more hydraulically close or least demanding sprinklers 523. Preferably, the design criteria provides the maximum and minimum fluid delivery delay periods for the system to be respectively located at the most hydraulically remote sprinklers 521 and the most hydraulically close sprinklers 523. The designed maximum and minimum fluid delivery delay periods being configured to ensure that each sprinkler in the system 500 has a designed fluid delivery delay period within the maximum and minimum fluid delivery delay periods to permit fire growth in the presence of a fire even to thermally actuate a sufficient number of sprinklers to form a sprinkler operational area effectively equivalent to the IDA of an appropriately configured wet system to address the fire event.

Because a dry sprinkler fire protection system can be hydraulically configured as a function of the IDA in an appropriately configured wet system, the preferred maximum and minimum fluid delivery periods can be functions of the hydraulic configuration, the occupancy ceiling height, and storage height in an appropriately configured wet system. Accordingly, the maximum and minimum fluid delivery time design criteria can be embodied in a database, data table and/or look-up table derived from and corresponding to data collected for various configurations of wet systems.

Alternatively to designing, manufacturing and/or qualifying a preferred dry sprinkler system incorporating the design methodology described above, or any of its subsystems or components, the process of obtaining the preferred system or any of its qualified components can entail, for example, acquiring such a system, subsystem or component. Acquiring the qualified sprinkler can further include receiving a qualified sprinkler 20, a preferred dry sprinkler system 500, as shown for example in FIG. 6 or the designs and methods of such a system as described above from, for example, a supplier or manufacturer in the course of a business-to-business transaction, through a supply chain relationship such as between, for example, a manufacturer and supplier; between a manufacturer and retail supplier; or between a supplier and contractor/installer. Alternatively acquisition of the system and/or its components can be accomplished through a contractual arrangement, for example, a contractor/installer and storage occupancy owner/operator, property transaction such as, for example, sale agreement between seller and buyer, or lease agreement between leasor and leasee.

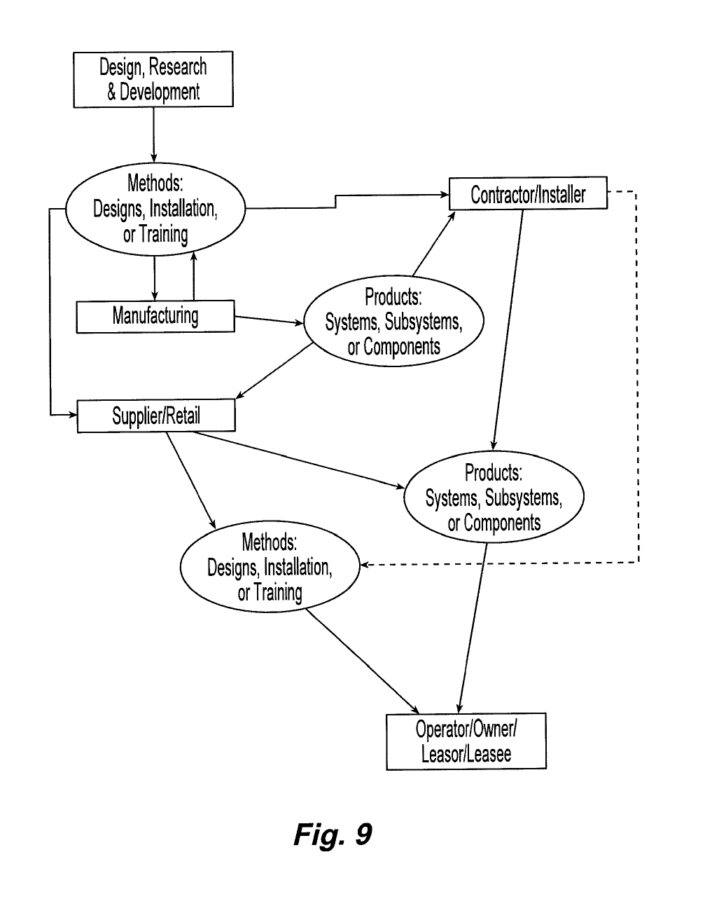

In addition, the preferred process of providing a method of fire protection can include distribution of the preferred dry sprinkler system 10, its subsystems, components and/or its methods of design, configuration and use in connection with the transaction of acquisition as described above. The distribution of the system, subsystem, and/or components, and/or its associated methods can includes the process of packaging, inventorying or warehousing and/or shipping of the system, subsystem, components and/or its associated methods of design, configuration and/or use. The shipping can include individual or bulk transport of the sprinkler 20 over air, land or water. The avenues of distribution of preferred products and services can include those schematically shown, for example, in FIG. 9. FIG. 9 illustrates how the preferred systems, subsystems, components and associated preferred methods of fire protection can be transferred from one party to another party. For example, the preferred sprinkler design for a sprinkler qualified to be used in a preferred dry sprinkler system 10 can be distributed from a designer to a manufacturer. Methods of installation and system designs for the preferred sprinkler system 10 can be transferred from a manufacture to a contractor/installer.

In one preferred aspect of the process of distribution, the process can further include publication of the preferred sprinkler system configuration, the subsystems, components and/or associated sprinklers, methods and applications of fire protection. For example, the sprinkler 20 can be published in a catalog for a sales offering by any one of a manufacturer and/or equipment supplier. The catalog can be a hard copy media, such as a paper catalog or brochure or alternatively, the catalog can be in electronic format. For example, the catalog can be an on-line catalog available to a prospective buyer or user over a network such as, for example, a LAN, WAN or Internet.

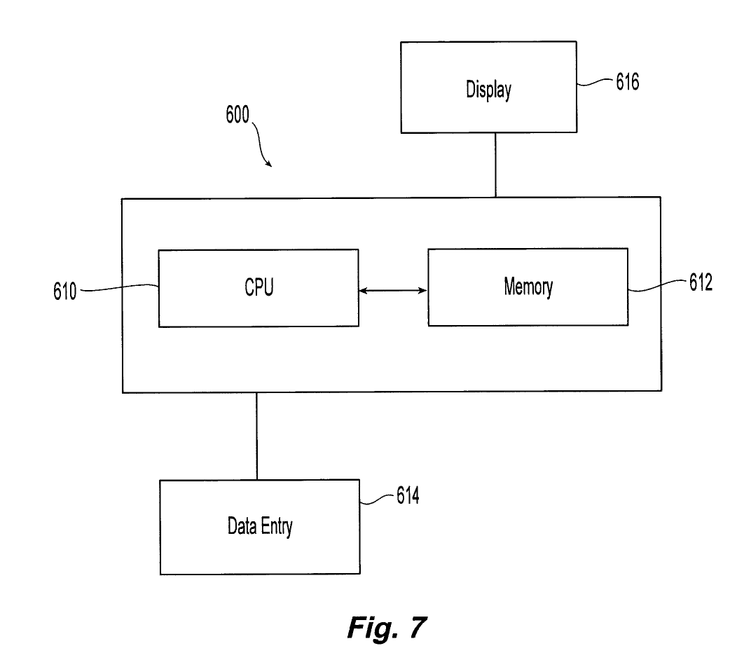

FIG. 7 shows a computer processing device 600 having a central processing unit 610 for performing memory storage functions with a memory storage device 611, and further for performing data processing or running simulations or solving calculations. The processing unit and storage device can be configured to store, for example, a database of fire test data to build a database of design criteria for configuring and designing a sprinkler system employing a preferred fluid delivery delay period as previously described. Moreover, the device 600 can perform calculating functions such as, for example, solving for sprinkler activation time and fluid distribution times from a constructed sprinkler system model. The computer processing device 600 can further include, a data entry device 612, such as for example, a computer keyboard and a display device, such as for example, a computer monitor in order perform such processes. The computer processing device 600 can be embodied as a workstation, desktop computer, laptop computer, handheld device, or network server.

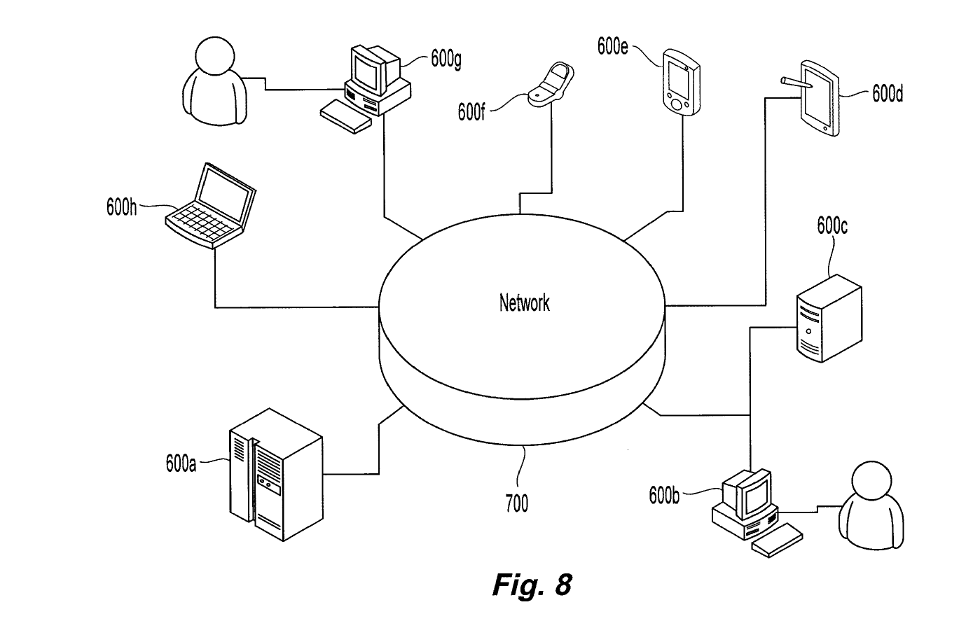

One or more computer processing devices 600a-600h can be networked over a LAN, WAN, or Internet as seen, for example as seen, in FIG. 8 for communication to effect distribution of preferred fire protection products and services associated with addressing a fire. Accordingly, a system and method is preferably provided for transferring the preferred fire protection system 10, subsystems, system components and/or associated methods such as the preferred design methodology 100. The transfer can occur between a first party using a first computer processing device 600b and a second party using a second computer processing device 600c. The method preferably includes offering a qualified sprinkler for use in a dry sprinkler system for a storage occupancy up to a ceiling height, for example, of about thirty-five feet having a commodity stored up to about, for example, thirty feet and delivering the qualified sprinkler in response to a request for a sprinkler for use in ceiling only fire protection system.

Offering a qualified sprinkler preferably includes publishing the qualified sprinkler in at least one of a paper publication and an on-line publication. Moreover, the publishing in an on-line publication preferably includes hosting a data array about the qualified sprinkler on a computer processing device such as, for example, a server 600a and its memory storage device 612a, preferably coupled to the network for communication with another computer processing device 600g such as for example, 600d. Alternatively any other computer processing device such as for example, a laptop 600h, cell phone 600f, personal digital assistant 600e, or tablet 600d can access the publication to receive distribution of the sprinkler and the associated data array. The hosting can further include configuring the data array so as to include a listing authority element, a K-factor data element, a temperature rating data element and a sprinkler data configuration element. Configuring the data array preferably includes configuring the listing authority element as for example, being UL, configuring the K-factor data element as being about seventeen, configuring the temperature rating data element as being about 286° F., and configuring the sprinkler configuration data element as upright. Hosting a data array can further include identifying parameters for the dry sprinkler system, the parameters including: a hydraulic design area including a sprinkler-to-sprinkler spacing, a maximum fluid delivery delay period to a most hydraulically remote sprinkler, and a minimum fluid delivery delay period to the most hydraulically close sprinkler.

The preferred process of distribution can further include distributing the preferred method 100 for designing a fire protection system. Distributing the method can include publication of a database of design criteria as an electronic data sheet, such as for example, at least one of an .html file, .pdf, or editable text file. The database can further include, in addition to the data elements and design parameters described above, another data array identifying a riser assembly for use with the sprinkler of the first data array, and even further include a sixth data array identifying a piping system to couple the control valve of the fifth data array to the sprinkler of the first data array.

An end or intermediate user of fire protection products and services can access a server or workstation of a supplier of such products or services over a network as seen in FIG. 8 to download, upload, access or interact with a distributed component or system brochure, software applications or design criteria for practicing, learning, implementing, or purchasing the preferred design methodology 100 of fire protection and its associated products. For example, a system designer or other intermediate user can access a product data sheet for a preferred fire protection system 10 configured to address a fire event in order to acquire or configure such a sprinkler system incorporating a preferred fluid delivery delay period. Furthermore a designer can download or access data tables for fluid delivery delay periods, as described above, and further use or license simulation software, such as for example the described in PCT International Patent Application No. PCT/US06/38360, to iteratively design a preferred fire protection system 10.

Where the process of distribution provides for publication of the preferred dry sprinkler systems described above, its subsystems and its associated methods in a hard copy media format, the distribution process can further include, distribution of the cataloged information with the product or service being distributed. For example, a paper copy of the data sheet for the sprinkler 20 can be include in the packaging for the sprinkler 20 to provide installation or configuration information to a user. The hard copy data sheet can preferably include the necessary data tables and hydraulic design criteria to assist a designer, installer, or end user to configure a sprinkler system for storage occupancy incorporating the design methodology as described above.

Accordingly, applicants have provided an approach to fire protection based upon the IDA of an appropriately configured wet system. This approach can be embodied in systems, subsystems, system components and design methodologies for implementing such systems, subsystems and components. While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A dry sprinkler system for protection of a storage occupancy comprising:
a network of pipes including a wet portion and a dry portion connected to the wet portion, the dry portion configured to respond to a fire with at least a first activated sprinkler; and
a fluid delivery delay period to deliver fluid from the wet portion to the at least first activated sprinkler, the delay period being of a sufficient length such that the dry portion further responds to the fire with at least a second activated sprinkler, the delay period being no greater than a critical burn time of a wet system configured to protect the same storage occupancy.

2. The dry sprinkler system of claim 1, wherein the at least first activated sprinkler comprises a plurality of initially activated sprinklers in response to the fire.

3. The dry sprinkler system of claim 2, wherein the plurality of initially activated sprinklers are thermally activated in a defined sequence.

4. The dry sprinkler system of claim 1, wherein the system includes a primary water control valve providing controlled separation between the wet portion and the dry portion, and the dry portion includes at least one hydraulically remote sprinkler and at least one hydraulically close sprinkler relative to the primary water control valve.

5. The dry sprinkler system of claim 4, wherein the fluid delivery delay period defines a minimum fluid delivery delay period and a maximum fluid delivery delay period, the minimum fluid delivery delay period defining the time to deliver fluid from the control valve to the at least one hydraulically close sprinkler, the maximum fluid delivery delay period defining the time to deliver fluid from the control valve to the at least one hydraulically close sprinkler.

6. The dry sprinkler system of claim 1, wherein the dry portion includes a plurality of sprinklers having a K-factor of about 11 or greater and an operating pressure of about 15 psi. or greater, the dry portion being disposed above a commodity comprising at least one of Class I-IV, Group A, Group B or Group C with a storage height greater than twenty-five feet.

7. The dry sprinkler system of claim 6, wherein the plurality of sprinklers have a K-factor ranging from about 11 to about 36.

8. The dry sprinkler system of claim 7, wherein the K-factor is about 17.

9. The dry sprinkler system of claim 8, wherein the K-factor is about 16.8.

10. The dry sprinkler system of claim 6, wherein the operating pressure ranges from about 15 psi. to about 60 psi.

11. The dry sprinkler system of claim 10, wherein the operating pressure ranges from about 15 psi. to about 45 psi.

12. The dry sprinkler system of claim 11, wherein the operating pressure ranges from about 20 psi. to about 35 psi.

13. The dry sprinkler system of claim 12, wherein the operating pressure is about 35 psi.

14. The dry sprinkler system of claim 1, wherein fluid delivery delay period defines a sprinkler operational area within about ten minutes following the activation of the at least first activated sprinkler.

15. The dry sprinkler system of claim 14, wherein the sprinkler operational area is defined within about eight minutes following the activation of the at least first activated sprinkler.

16. The dry sprinkler system of claim 15, wherein the sprinkler operational area is defined within about five minutes following the activation of the at least first activated sprinkler.

17. A method of designing a dry sprinkler system for a storage occupancy having a network of pipes including a wet portion and a dry portion, the method comprising:
determining the inherent design area of a wet system configured to protect the same storage occupancy;
determining a critical burn time to form the inherent design area; and
incorporating a fluid delivery delay period into the dry system, the fluid delivery delay period being no greater than the critical burn time.

18. The method of claim 17, wherein the determining the fluid delivery delay period comprises determining a maximum fluid delivery delay period for fluid delivery to a most hydraulically remote sprinkler in the dry portion.

19. The method of claim 17, wherein the determining the fluid delivery delay period comprises determining a minimum fluid delivery delay period to a most hydraulically close sprinkler in the dry portion.

20. The method of claim 18, further comprising modeling the dry portion as a network of sprinklers having a stored commodity below the network, modeling a fire scenario in the commodity and solving for the sprinkler activation time for each sprinkler relative to the ignition time.

21. The method of claim 20, wherein determining the critical burn time includes graphing each of the activation times to generate a predictive sprinkler activation profile.

22. The method of claim 17, wherein defining the fluid delivery delay period defines a hydraulic design area no greater than the design area specified by NFPA-13 (2002) for the same commodity being protected.
